(19) United States
(12) Patent Application Publication
(10) Pub. No.: US 2021/0172164 A1
(43) Pub. Date: Jun. 10, 2021

(54) MODULAR HOUSING AND RELATED SYSTEMS AND MANUFACTURE

(71) Applicant: BLOKABLE, INC., Seattle, WA (US)

(72) Inventors: Aaron H. Holm, Issaquah, WA (US); Nelson Del Rio, Redding, CA (US); Timothy B. Miller, Seattle, WA (US); Przemyslaw Olszewski, Portland, OR (US); Sandra K. Anuras, Seattle, WA (US); Justin Huff, Seattle, WA (US); Sungyong Kim, Edmonds, WA (US)

(21) Appl. No.: 17/052,442

(22) PCT Filed: May 2, 2019
(86) PCT No.: PCT/US2019/030465

§ 371 Date: Nov. 2, 2020

Related U.S. Application Data
(60) Provisional application No. 62/666,422, filed on May 3, 2018.

(51) Int. Cl. E04B 1/348; E05B 63/00; E04F 15/02; E04B 1/66; E04B 1/88; E04H 1/00; E04H 1/04; G05B 15/02; G08B 21/18

(52) U.S. Cl. CPC E04B 1/34869; E04B 1/3483; E05B 63/0065; E04F 15/02188; E04B 1/66; A62C 37/44; E04H 1/005; E04H 1/04; G05B 15/02; G08B 21/18; E04B 1/88

(57) ABSTRACT

Systems and methods for modular dwelling units that may be combined into a modular building. The modular dwelling units may be fluidly isolated from each other by a sealing system that prevents fluids from leaking into adjacent modular dwelling units, and a subfloor system that is tilted to drain fluids towards a conduit that leads away from the modular building. The modular dwelling units may include one or more sensors that generate signals based upon conditions within the modular dwelling unit and/or based on occupants of the modular dwelling unit. The modular dwelling units may include one or more processor-based devices that may generate an alarm and/or control one or more actuators or valves in response to the signals received from the sensors.

### TECHNICAL FIELD

The present implementations relate to a modular habitual structure, and specific structures and systems that enhance a robustness of the structure.

### BACKGROUND

In recent years, the availability of affordable housing has become an issue for many communities around the country and throughout the world. Certain segments of the population, such as the poor or elderly, may be especially susceptible to the increased cost and decreased availability of housing. As a result, many people are either living in substandard housing or are forced to commute long distances to work at their jobs. One of the issues exacerbating this housing crisis is the amount of time and resources that are necessary to construct a single family home or a multi-unit dwelling. Such construction times can take anywhere from several weeks to several months or more, and may require teams of workers and contractors to construct a home or dwelling at a construction site.

In addition to time constraints, current building practices also rely upon a division of labor and responsibilities to incorporate technology into the home or dwelling unit. As such, a primary contractor may be responsible for erecting the structural components that are used to build the home or dwelling. Separate contractors or workers may then be called upon to modify the existing walls or other structural components to incorporate various types of technologies and capabilities, including networking, communications, and sensing capabilities, into the structure.

### SUMMARY

Modular structure may be used to decrease construction time for various types of dwelling units. At least portions of such modular units may pre-fabricated at a facility located away from the construction site, and shipped to the construction site to be quickly and efficiently incorporated into the modular structure. Because such portions may be pre-fabricated to be included within multiple types of modular structures, the cost of such fabrication may be kept relatively low. In addition, certain types of features (e.g., sensors, piping, conduits) may be formed as an integral part of such pre-fabricated units thereby decreasing the amount of time and labor costs that may be necessary to build the modular structure. In such an implementation, the various features and/or technologies may be incorporated into a dashboard that may be used to provide a comprehensive overview of conditions within the modular structure and execute one or more actions based one such an overview.

The modular structure may also include one or more components that may be used to protect each modular structure from damage caused by events in other, adjacent modular structures. For example, some modular structures may include a subfloor that may be arranged to drain one or more types of fluid away from the modular structure when such fluids may be present (e.g., during a flooding event caused by an activated sprinkler system, overflowing bath, sink, toilet, dishwasher or washing machine), Accordingly, a plurality of such modular structures may form a modular building that may be used as a multi-unit dwelling for multiple occupants. In such an implementation, the subfloors may be used to minimize or prevent damage caused by actions in one of the dwelling units from having an impact on other dwelling units in the modular building.

A modular structure may be summarized as including a floor, the floor having an upper surface and a lower surface, the lower surfaced opposed from the upper surface across a thickness of the floor, the upper surface being substantially horizontal and permeable to at least one type of liquid; and a subfloor, the subfloor having an upper surface, the subfloor spaced relative beneath lower surface of the floor with the upper surface of the subfloor facing toward the lower surface of the floor and a gap between at least a portion of the lower surface of the floor and the upper surface of the subfloor, at least a majority of the upper surface of the subfloor being titled with respect to the upper surface of the floor to drain that at least one type of liquid in one or more defined directions. The floor may include a plurality of perforations extending therethrough to provide fluidly communicative paths between the upper and lower surfaces of the floor.

The modular structure may be a modular dwelling unit, and may further include a plurality of modular walls and a frame comprised of a plurality of structural members, the floor and the modular walls physically coupled to the frame.

The modular structure may further include at least one conduit fluidly coupled to the gap, and which provides a fluid flow path away from the modular dwelling unit. The gap and the at least one conduit may fluidly isolate the modular dwelling unit from neighboring modular dwelling units. The modular dwelling unit may have a perimeter and the upper surface of the subfloor may slope downwardly as the subfloor is traversed outwardly from an interior toward at least a portion of the perimeter of the modular dwelling unit. The modular dwelling unit may have a perimeter and at least one perimeter channel that extends along at least a portion of the perimeter, and the upper surface of the subfloor may slope downwardly as the subfloor is traversed outwardly from an interior toward the at least one perimeter channel. The modular dwelling unit may have a perimeter and the upper surface of the subfloor may slope downwardly as the subfloor is traversed inwardly from at least a portion of the perimeter toward an inwardly spaced location. The modular dwelling unit may have a perimeter and at least one interior channel that is spaced away from the perimeter, and the upper surface of the subfloor may slope downwardly as the subfloor is traversed inwardly from at least a portion of the perimeter toward the at least one interior channel. The structural members may each include steel structural members. The floor may include at least a first steel layer.

The floor may further include at least a non-metal layer overlying the first steel layer, and the perforations extend through both the first steel layer and the non-metal layer.

The modular structure may further include at least one sensor responsive to detection of a presence of a liquid, the at least one sensor operable to produce an alert in response to detection of the presence of the liquid. The at least one sensor may be responsive to the presence of the liquid in the gap, the at least one sensor may be operable to produce the alert in response to detection of the presence of the liquid in the gap. The at least one sensor may be an integral component of the floor or the subfloor.

The modular structure may further include at least one valve fluidly coupled to control a flow of water into the modular structure, the at least one valve selectively operable to stop a flow of water into the modular structure.

The modular structure may further include at least one sensor responsive to an occurrence of a leak, the at least one sensor operable to produce an alert in response to detection of the occurrence of a leak. The at least one valve may be communicatively coupled to respond to detection of the occurrence of a leak by the at least one sensor. The at least one valve may be communicatively coupled to respond to human generated command.

The modular structure may further include a plurality of sprinklers; a first supply network fluidly coupled to provide water to the plurality of sprinklers; a second supply fluidly coupled to provide water to at least one of a faucet, a toilet, or a shower head; and at least one valve fluidly coupled to control a flow of via the second supply, the at least one valve selectively operable to stop a flow of water into the modular structure.

A modular building may be summarized as including a plurality of modular dwelling units, each of the modular dwelling units have a respective floor, a respective ceiling, and at least one respective perimeter wall, the respective floor, respective ceiling and at least one respective perimeter wall delimiting a respective interior of the modular dwelling unit from a respective exterior of the modular dwelling unit, the modular dwelling units physically coupled to a number of nearest neighboring ones of the modular dwelling units via at least one coupler with a gap between each of the modular dwelling units and all of the other module dwelling units which are the nearest neighboring ones of the modular dwelling units. The respective floor of each of the modular dwelling units may include an upper surface and a lower surface, the lower surfaced opposed from the upper surface across a thickness of the floor, the upper surface being substantially horizontal and permeable to at least one type of liquid.

Each of the modular dwelling units may further include a subfloor, the subfloor having an upper surface, the subfloor spaced relative beneath lower surface of the floor with the upper surface of the subfloor facing toward the lower surface of the floor and a gap between at least a portion of the lower surface of the floor and the upper surface of the subfloor, at least a majority of the upper surface of the subfloor being titled with respect to the upper surface of the floor to drain that at least one type of liquid in one or more defined directions. The floor may include a plurality of perforations extending therethrough to provide fluidly communicative paths between the upper and lower surfaces of the floor.

The perimeter walls may be modular perimeter walls, and may further include a frame comprised of a plurality of structural members, the floor and the modular perimeter walls are physically coupled to the frame.

The modular structure may further include a plurality of sealing systems that each provide a respective waterproof and airtight seal between a respective one of the structural members and one of the floor, the ceiling or modular perimeter walls. Each of the sealing systems may include at least one portion that is repairable or replaceable. Each of the modular perimeter walls may include one or more modular perimeter wall panels, the modular perimeter wall panels each including a cold rolled steel layer and a thermal and acoustic insulation layer. Each of the ceilings may include one or more modular ceiling panels, the modular ceiling panels each including a cold rolled steel layer and a thermal and acoustic insulation layer. At least a first one of the modular dwelling units may be spaced above at least a second one of the modular dwelling units, and at least the second one of the modular dwelling units may be spaced laterally from at least a third one of the modular dwelling units, the first, the second, and the third modular dwelling units each being respective modular dwelling units, distinct from one another.

A modular building component may be summarized as including a pre-fabricated structural member; and at least one sensor integral to the pre-fabricated structural member.

The modular building component may further include at least one wired access connector integral to the pre-fabricated structural member.

The modular building component may further include at least one wire, cable or optical fiber integral to the pre-fabricated structural member.

The modular building component may further include at least one circuit board integral to the pre-fabricated structural member. The pre-fabricated structural member may include at least one passage therein to receive at least one of a wire, a cable, an optical fiber, or a fluid conduit. The pre-fabricated structural member may be one of a wall panel, a ceiling panel, a floor panel, or a structural member. The at least one sensor may include one or more of a water sensor, a humidity sensor, a temperature sensor, a carbon monoxide sensor, a smoke detector, a passive infrared motion detector, an image sensor, a microphone, an accelerometer, an impact sensor, a pressure sensor, a load cell, an air flow sensor, a gas flow sensor, a light detection and ranging (LIDAR) sensor, and a radar sensor. The pre-fabricated structural member may be modular wall panel which includes a cold rolled steel layer and a thermal and acoustic insulation layer. The modular wall panel may be replaceable as an integral unit. The modular wall panel may be fire resistant, water resistant, and rot resistant. The modular building component may have a unique identifier readable therefrom. The unique identifier readable may be one of a human-readable symbol, a machine-readable symbol or a radio frequency identification (RFID) transponder encoded identifier.

A modular building may be summarized as including a plurality of modular dwelling units, each of the modular dwelling units have a respective floor, a respective ceiling, and at least one respective perimeter wall, the respective floor, respective ceiling and at least one respective perimeter wall delimiting a respective interior of the modular dwelling unit from a respective exterior of the modular dwelling unit, the modular dwelling units physically coupled to a number of nearest neighboring ones of the modular dwelling units via at least one coupler, each of the modular dwelling units have a respective set of sensors to monitor a number of physical characteristics of the modular dwelling unit and a number of physical characteristics of any inhabitants of the modular dwelling units.

Each of the modular dwelling units may further include a respective communications hub which provides communications between the respective set of sensors and at least one remote monitoring system.

Each of the modular dwelling units may further include a respective communications hub which provides communications between the respective set of sensors and at least one remote cloud-based monitoring system. The respective set of sensors may each include one or more of a water sensor, a humidity sensor, a temperature sensor, a carbon monoxide sensor, a smoke detector, a passive infrared motion detector, an image sensor, a microphone, an accelerometer, an impact sensor, a pressure sensor, a load cell, an air flow sensor, a gas flow sensor, a light detection and ranging (LIDAR) sensor, and a radar sensor. Each of the sensors may have a unique identifier readable therefrom. Each of the sensors may have a wired or optical fiber connection to provide communications therefrom. The sensors of the respective sets of sensors may each be integral to one or more pre-fabricated modular building components. The modular building component may have a unique identifier readable therefrom. The unique identifier may be one of a human-readable symbol, a machine-readable symbol or a radio frequency identification (RFID) transponder encoded identifier. The modular dwelling units may be physically coupled to the number of nearest neighboring ones of the modular dwelling units with a gap between each of the modular dwelling units and all of the other module dwelling units which are the nearest neighboring ones of the modular dwelling units.

A monitoring system may be summarized as including at least a first processor-based system comprising at least one processor and at least one non-transitory processor-readable medium that stores at least one of processor-executable instructions or data which, when executed by the at least one processor, causes the at least one processor to: monitor each sensor of a respective set of sensors for each of a plurality of modular dwelling units, each of the modular dwelling units have a respective floor, a respective ceiling, and at least one respective perimeter wall, the respective floor, respective ceiling and at least one respective perimeter wall delimiting a respective interior of the modular dwelling unit from a respective exterior of the modular dwelling unit, the modular dwelling units physically coupled to a number of nearest neighboring ones of the modular dwelling units via at least one coupler, the respective set of sensors of each of the modular dwelling units operable to sense a number of physical characteristics of the modular dwelling unit and a number of physical characteristics of any inhabitants of the modular dwelling units and produce at least one alert in response to one or more or a combination of the sensed physical characteristics of the modular dwelling unit or the sensed physical characteristics of any inhabitants of the modular dwelling units at least one of not meeting a first defined condition or meeting a second defined condition.

The processor-executable instructions or data, when executed by the at least one processor, may further cause the at least one processor to present a dashboard representing the sensed physical characteristics of the modular dwelling unit or the sensed physical characteristics of any inhabitants of the modular dwelling units.

The processor-executable instructions or data, when executed by the at least one processor, may further cause the at least one processor to present a dashboard representing the sensed physical characteristics of the modular dwelling unit or the sensed physical characteristics of any inhabitants of all of the modular dwelling units to an authorized building monitor.

The processor-executable instructions or data, when executed by the at least one processor, may further cause the at least one processor to present a dashboard representing the sensed physical characteristics of the modular dwelling unit or the sensed physical characteristics of any inhabitants of a first one of the modular dwelling units to an authorized inhabitant of the first one of the modular dwelling units and not to inhabitants of other ones of the modular dwelling units.

The processor-executable instructions or data, when executed by the at least one processor, may further cause the at least one processor to implement a controller that allows remote control over actuators of respective sets of one or more actuators for each of the modular dwelling units.

The processor-executable instructions or data, when executed by the at least one processor, may further cause the at least one processor to implement a controller that allows local control over actuators of respective sets of one or more actuators for each of the modular dwelling units via one or more authorized inhabitants of the respective modular dwelling units.

A method of operation in a monitoring system that includes at least one processor and at least one non-transitory processor-readable medium that stores at least one of processor-executable instructions or data executable by the at least one processor may be summarized as including detecting an addition of a new modular dwelling unit to a network of modular dwelling units, each of the modular dwelling units having a respective floor, a respective ceiling, and at least one respective perimeter wall, the respective floor, respective ceiling and at least one respective perimeter wall delimiting a respective interior of the modular dwelling unit from a respective exterior of the modular dwelling unit, the modular dwelling units physically coupled to a number of nearest neighboring ones of the modular dwelling units via at least one coupler, the respective set of sensors of each of the modular dwelling units operable to sense a number of physical characteristics of the modular dwelling unit and a number of physical characteristics of any inhabitants of the modular dwelling units; and monitoring each sensor of a respective set of sensors for each of a plurality of modular dwelling units, each of the modular dwelling units have a respective floor, a respective ceiling, and at least one respective perimeter wall, the respective floor, respective ceiling and at least one respective perimeter wall delimiting a respective interior of the modular dwelling unit from a respective exterior of the modular dwelling unit, the modular dwelling units physically coupled to a number of nearest neighboring ones of the modular dwelling units via at least one coupler, the respective set of sensors of each of the modular dwelling units operable to sense a number of physical characteristics of the modular dwelling unit and a number of physical characteristics of any inhabitants of the modular dwelling units.

The method may further include producing at least one alert in response to one or more or a combination of the sensed physical characteristics of the modular dwelling units or the sensed physical characteristics of any inhabitants of the modular dwelling units at least one of not meeting a first defined condition or meeting a second defined condition.

The method may further include in response to one or more or a combination of the sensed physical characteristics of the modular dwelling units or the sensed physical characteristics of any inhabitants of the modular dwelling units at least one of not meeting a first defined condition or meeting a second defined condition, transmitting at least one alert to a device located remotely from the dwelling units.

The method may further include in response to one or more or a combination of the sensed physical characteristics of a first one of the modular dwelling units or the sensed physical characteristics of any inhabitants of the first one of the modular dwelling units at least one of not meeting a first defined condition or meeting a second defined condition, transmitting at least one alert to a device located a second one of the dwelling units.

The method may further include in response to one or more or a combination of the sensed physical characteristics of a first one of the modular dwelling units or the sensed physical characteristics of any inhabitants of the first one of the modular dwelling units at least one of not meeting a first defined condition or meeting a second defined condition, transmitting at least one alert to a device located at all of the other ones of the dwelling units.

The method may further include presenting a dashboard representing the sensed physical characteristics of the modular dwelling units or the sensed physical characteristics of any inhabitants of the modular dwelling units.

The method may further include presenting a dashboard representing the sensed physical characteristics of the modular dwelling units or the sensed physical characteristics of any inhabitants of the modular dwelling units at a location that is remote from the modular dwelling units. Presenting a dashboard may include presenting a dashboard representing the sensed physical characteristics of a first one of the modular dwelling units or the sensed physical characteristics of any inhabitants of the first one of the modular dwelling units via a device operated by a manager of the modular dwelling units.

The method may further include presenting a dashboard representing the sensed physical characteristics of a first one of the modular dwelling units or the sensed physical characteristics of any inhabitants of the first one of the modular dwelling units via a device associated with an inhabitant of the first modular dwelling unit, Presenting a dashboard may include presenting a dashboard representing the sensed physical characteristics of a first one of the modular dwelling units or the sensed physical characteristics of any inhabitants of the first one of the modular dwelling units via, a device operated by one of the inhabitants of the first modular dwelling unit, Presenting a dashboard may include presenting a dashboard representing the sensed physical characteristics of a first one of the modular dwelling units or the sensed physical characteristics of any inhabitants of the first one of the modular dwelling units via a device operated by at least one casework assigned to work with at least one of the inhabitants of the first modular dwelling unit.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

The various embodiments of the present motion detection based on image data and non-image data will be discussed in detail with an emphasis on highlighting the advantageous features. These embodiments depict the novel and non-obvious motion detection based on image data and non-image data shown in the accompanying drawings, which are for illustrative purposes only. These drawings include the following figures, in which like numerals indicate like parts:

FIG. 1A is a perspective view of a modular structure having a subfloor that is tilted to slope downwardly towards a center portion of the modular structure, according to at least one illustrated implementation.

FIG. 1B is a perspective view of a modular structure having a subfloor that is tilted to slope downwardly towards an outside edge of the modular structure, according to at least one illustrated implementation.

FIG. 2A is a top, side isometric view of a portion of a modular wall panel, according to at least one illustrated implementation.

FIG. 2B is a bottom, side isometric view of a portion of a modular ceiling panel, according to at least one illustrated implementation.

FIG. 3 is a top, side isometric view of a portion of a floor that includes a first steel layer and a non-metal layer overlaying the first steel layer in which perforations extend through both the first steel layer and the non-metal layer, according to at least one illustrated implementation.

FIG. 4 is a top, side isometric view of a roof that is physically coupled to a modular structure, according to at least one illustrated implementation.

FIG. 5A is a side perspective view of a modular building comprised of a plurality of modular dwelling units, each of which is physically coupled to one or more adjacent modular dwelling units, in which fluid drains through one or more fluidly communicative paths located towards a center portion of each modular dwelling unit, according to at least one illustrated implantation.

FIG. 5B is a side perspective view of a modular building comprised of a plurality of modular dwelling units, each of which is physically coupled to one or more adjacent modular dwelling units, in which fluid drains through one or more fluidly communicative paths located towards a perimeter of the modular building, according to at least one illustrated implantation.

FIG. 6 is a perspective view of a modular building comprised of two adjacent modular dwelling units with a modular wall placed along an interior portion of the modular building, according to at least one illustrated implementation.

FIG. 7 is a plan view of a display of a dashboard in which information about a modular dwelling unit is rendered, according to at least one illustrated implementation.

FIG. 8 is a schematic diagram showing a processor-based system that may be used to receive signals from one or more sensors, generate control signals for one or more actuators and/or valves, and activate an alarm signal based on one or more criteria, according to at least one illustrated implementation

FIG. 9 is a logic flow diagram of an example method of monitoring the signals received from one or more of the sensors in one of the modular dwelling units, according to at least one illustrated implementation.

FIG. 10 is a logic flow diagram of an example method of generating an alarm based on one or more of the signals received from respective sensors in one or more of the modular dwelling units, according to at least one illustrated implementation.

FIG. 11 is a logic flow diagram of an example method of recognizing and becoming communicatively coupled with a modular dwelling unit that has been added to existing modular dwelling units in a modular building, according to at least one illustrated implementation.

### DETAILED DESCRIPTION

The following detailed description describes the present implementations with reference to the drawings. Example methods, apparatuses, and systems described herein are not intended to limit the scope of the description to the precise form or forms detailed herein. Instead the following description is intended to be illustrative so that others may follow its teachings.

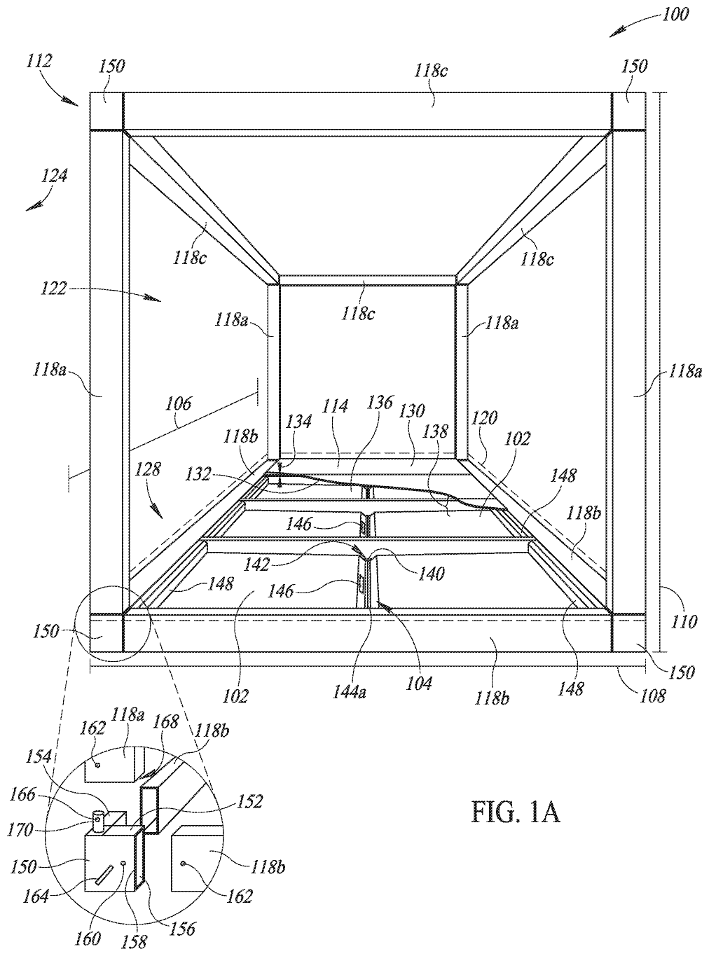

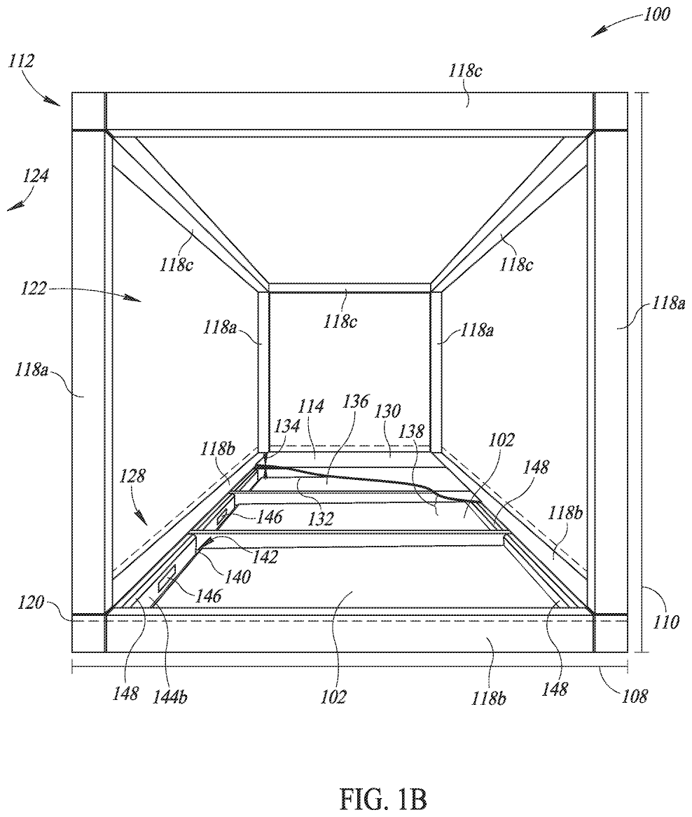

FIG. 1A shows a modular structure 100 having a subfloor 102 that is tilted to slope downwardly towards an interior portion 104 of the modular structure 100 according to at least one illustrated implementation. FIG. 1B shows a modular structure 100 having a subfloor 102 that is tilted to slope downwardly towards a portion of a perimeter of the modular structure 100, according to at least one illustrated implementation. The modular structure 100 may have a length 106, a width 108, and a height 110. In some implementations, the modular structure 100 may also include a frame 112 and a floor 114. The frame 112 may be comprised of metal (e.g., steel), a composite material (e.g., oriented strand board, fiber reinforced polymers), or other materials. The frame 112 may extend through one or more of the length 106, the width 108, and/or the height 110 of the modular structure 100, and may delineate an interior portion 122 of the modular structure 100 from an exterior 124 of the modular structure 100. All or substantially all of the materials employed in the modular structure 100 may be fireproof or fire resistant (e.g., glass fiber reinforced sheetrock, steel, mineral wool) and/or may have a tire retardant coating or covering thereon.

The frame 112 may include one or more structural frame members 118. Each of the structural members of the frame 112 may extend along one or more of the length 106, width 108, and/or height 110 of the modular structure 100. The structural members may be used to outline a shape for the modular structure 100. For example, the structural members may include a set of vertical structural frame members 118a, a set of lower horizontal structural frame members 118b, and a set of upper horizontal structural frame members 118c that may be used to outline a cube. As such, the set of lower horizontal structural frame members 118b may include a first pair of opposing lower horizontal structural frame members 118b that extend along the length 106 of the modular structure 100, and a second pair of opposing lower horizontal structural frame members 118b that extend along the width 108 of the modular structure 100. The set of upper horizontal structural frame members 118c in such an implementation may include a first pair of opposing upper horizontal structural frame members 118c that extend along the length 106 of the modular structure 100, and a second pair of opposing upper horizontal structural frame members 118c that extend along the width 108 of the modular structure 100. The vertical structural frame members 118a in such an implementation may extend between the lower horizontal structure frame members 118b and the upper horizontal structural frame members 118c. In such an implementation, the set of lower horizontal members 118b may form a perimeter 120 of the modular structure 100. In some implementations, the structural members may be used to outline other types of shapes for the modular structure 100.

The dimensions of the modular structure 100 (e.g., the length 106, the width 108, and/or the height 110) may be based upon one or more criteria. Such criteria may reflect the environment and/or usage of the modular structure 100. For example, the dimensions of the modular structure 100 may be the same or substantially similar to the dimensions of one or more types of intermodal container (e.g., 20-foot containers or 40-foot containers) to facilitate transport via various modes of transportation (e.g., ships, trains, trucks) to a location. In such an implementation, the modular structure 100 may include other features or components that reflect the environment and/or usage of the modular structure 100. For example, in implementations in which the modular structure 100 has the same or substantially similar dimensions to a type of intermodal container, the modular structure 100 may include one or more couplers (e.g., twistlock fittings) at appropriate locations such that the modular structure 100 may be selectively, releaseably, physically coupled and secured to other intermodal containers for transport.

In some implementations, the modular structure 100 may include a floor 114 that extends across some or all of the length 106 and/or the width 108 of the modular structure 100 proximate a bottom portion 128 of the modular structure 100. The floor may be physically coupled to the frame 112 using one or more physical couplers (e.g., bolts, screws, nails, staples, adhesives). The floor 114 may include an upper surface 130 that faces toward the interior portion 122 of the modular structure 100 and an opposing lower surface 132 that faces toward the exterior 124 of the modular structure. The upper surface 130 may be separated from the opposing lower surface 132 by a thickness 134 of the floor 114 in which one or both of the upper surface 130 and the lower surface 132 may be substantially parallel to a horizontal plane. As such, the upper surface 130 may be used to support items located within the interior portion 122 of the modular structure. In some implementations, the floor 114 may be supported by one or more support members that may extend across length 106 and/or the width 108 of the modular structure. For example, in some implementations, one or more metal bars may extend across the width 108 of the modular structure 100 along the bottom portion 128 of the modular structure 100. The lower surface 132 of the floor 114 may thereby rest on top of such support members.

As discussed in more detail below, the floor 114 may be comprised of one or more layers of one or more types of materials. For example, the floor 114 may be comprised of one or more steel layers combined with one or more non-metal layers. Such non-metal layers may provide acoustic and/or thermal insulation. In some implementations, the one or more layers or materials that comprise the floor 114 may be permeable to one or more types of liquids. For example, as discussed below, the floor 114 may have a plurality of perforations that provide a fluidly communicative path from the upper surface 130 of the floor 114 to the lower surface of the floor 114. Such perforations may be used to drain fluids from the upper surface 130 of the floor 114 towards the lower surface 132 of the floor 114.

The subfloor 102 of the modular structure 100 may be located relatively beneath the lower surface 132 of the floor 114 and extend across some or all of the length 106 and/or width 108 of the modular structure 100 proximate the bottom portion 128 of the modular structure 100. The subfloor 102 may have an upper surface 136 that faces towards the lower surface 132 of the floor 114. In some such implementations, the upper surface 136 of the subfloor 102 may be separated from the lower surface 132 of the floor 114 by a gap 138. At least a portion of the upper surface 136 of the subfloor 102 is titled with respect to the lower surface 132 of the floor 114. In some implementations, a substantial portion (e.g., a majority) of the upper surface 136 of the subfloor 102 is so tilted. Such a tilt may be used to facilitate draining fluid in one or more directions towards one or more conduits 140 that may be fluidly coupled to the gap 138 between the upper surface 136 of the subfloor 102 and the lower surface 132 of the floor 114 to thereby provide a fluid flow path 142 through the conduit 140.

In some implementations, the upper surface 136 of the subfloor 102 may include one or more channels 144 that may be used to drain fluids towards the one or more conduits 140. Such channels 144 may thereby be used to drain fluid from the interior portion 122 of the modular structure 100. The channels 144 may include interior channels 144a (FIG. 1A) and perimeter channels 144b (FIG. 1B), and may be located relatively lower than the surrounding portions of the upper surface 136 to facilitate the flow of fluid towards the channels 144.

In some implementations, the interior channels 144a and associated conduits 140 may be located along the interior portion 104 of the subfloor 102. Such interior channels 144a may be located relatively away from the perimeter 120 of the modular structure 100, and may extend along all or a portion of one or both of the length 106 (FIG. 1A) and/or width 108 (not shown) of the modular structure 100. In such implementations, at least some portion(s) of the upper surface 136 of the subfloor 102 (e.g., a majority of the upper surface 136) may tilt downwardly as the subfloor 102 is traversed inwardly from at least a portion of the perimeter 120 toward an inwardly spaced location (e.g., the interior portion 104) of the subfloor 102 such that fluid will flow towards the interior channels 144.

In some implementations, the perimeter channels 144b and associated conduits 140 may be located proximate at least part of the perimeter 120 along the bottom portion 128 of the modular structure 100 (see, e.g., FIG. 1B). In some such implementations, at least some portion(s) of the upper surface 136 of the subfloor 102 (e.g., a majority of the upper surface 136) may slope downwardly as the subfloor 102 is traversed outwardly from the interior portion 104 of the subfloor 102 towards the part of the perimeter 120 that includes the perimeter channel 144b. In some such implementations, at least some portion(s) of the upper surface 136 of the subfloor 102 (e.g., a majority of the upper surface 136) may slope downwardly as the subfloor 102 is traversed from one edge of the subfloor 102 towards a second, opposing edge of the subfloor 102 at which the perimeter channel 144b is located (FIG. 1B). In each such implementation, the tilt of the subfloor 102 directs the flow of fluid towards the perimeter channel 144b and associated conduits 110 to thereby drain the fluid from the modular structure 100.

In some implementations, one or more liquid sensors 146 may be included with the modular structure 100. Such a liquid sensor 146 may be responsive to detect the presence of a liquid. In some implementations, for example, the liquid sensor 146 may be incorporated into a portion of one or more of the channels 144 in the subfloor 102. In some implementations, the liquid sensors 146 may be integrated into one or more components, such as the floor 114 and/or the subfloor 102, of the modular structure 100. As such, the liquid sensors 146 may be operable to detect fluid within the gap 138 between the floor 114 and the subfloor 102. In some such implementations, the liquid sensor 146 may be comprised of one or more capacitance transmitters each of which include a pair of opposing capacitor plates separated by a capacitor gap. Such capacitor plates may be arranged such that fluid will fill the area within the capacitor gap when the fluid moves through the associated channel 144. Because fluid has a different dielectric constant than air, the introduction of the fluid into the capacitor gap will change the capacitance between the opposing capacitor plates. In addition, different types of fluids may have different dielectric constants, which may result in different capacitances between opposing capacitor plates depending upon the type of fluid present in the capacitor gap. In some implementations, the liquid sensor 146 may generate one or more electrical signals in response to detecting the presence of a liquid. In some implementations, the liquid sensor 146 may generate an alarm in response to detecting the presence of a liquid. In such implementations, the liquid sensor 146 may be used to detect and/or confirm a leak within the modular structure 100.

The modular structure 100 may include one or more sealing systems 148 that may be used to create a waterproof seal and/or an air-tight seal within the modular structure 100 or between components thereof. The sealing system 148 may be comprised of material that is impermeable to fluid and/or air. Such material may include, for example, a plastic material, a polymer-based material, silicone, or any other such flexible material with such impermeability. In some such implementations, the sealing system 148 may be repairable and/or replaceable, for example, in the event of damage. In some implementations, the sealing systems 148 may be placed along a portion of one or more of the structural members (e.g., lower horizontal structural frame members 118b) to form a seal between the structural member and a surface (e.g., a wall, a ceiling, the floor 114, and/or the subfloor 102) that is proximate or adjacent to the respective structural member. As shown in FIGS. 1A and 1B, the sealing system 148 may be placed in the gap 138 between the floor 114 and the subfloor 102 to thereby provide a waterproof seal and an air-tight seal along the perimeter 120 of the modular structure 100 at the gap 138.

A number of structural frame members 118 may be physically coupled together using a connector 150, as shown in the call out in FIG. 1A. Each connector 150 may include a first leg 152 and a second leg 154 in which the first leg 152 and the second leg 1.54 are arranged at an angle to each other. The angle formed by the first leg 152 and the second leg 154 may be based, at least in part, on the shape of the modular structure 100. In implementations in which the modular structure 100 forms a cube or box, as shown in FIG. 1A, the first leg 152 and the second leg 154 may be arranged at a ninety degree angle with respect to each other. Each of the first leg 152 and the second leg 154 may have a respective cavity 156 (one shown) with an opening 158 that faces away from the connector 150. The opening 158 and/or the cavity 156 may be shaped and dimensioned to receive one of the structural frame members 118 in the modular structure 100. In some implementations, the opening 158 and/or cavity 156 may have dimensions that are only slightly larger than the outside dimensions of the structural frame member 118. As such the structural frame member 118 may form a close fitting or tight physical coupling with the opening 158 and/or cavity 156. In some implementations, one or more of the structural frame members 118 and the connector 150 may include a hollow cavity. In such implementations, such hollow cavities may be used to run one or more wires, cables, and/or optical fibers, as discussed below.

In some implementations, the connector 150 may have corresponding sidewall apertures 160 on opposing sidewalls of either or both of the first leg 152 and/or the second leg 154 (one shown in FIG. 1A). Each pair of opposing sidewall apertures 160 may align with a corresponding frame member aperture 162 when the structural frame member 118 is inserted into the cavity 156. The frame member aperture 162 may extend through the structural frame member 118 such that the structural frame member 118 may be selectively, releaseably, physically secured to the connector 150 by, for example, inserting a pin 164 through the opposing sidewall apertures 160 and the frame member aperture 162.

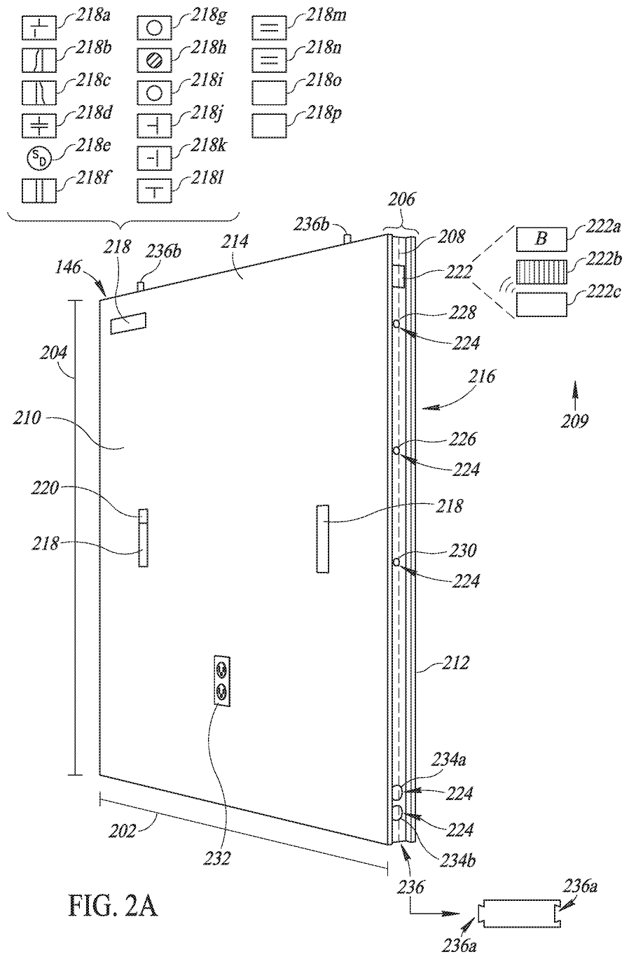

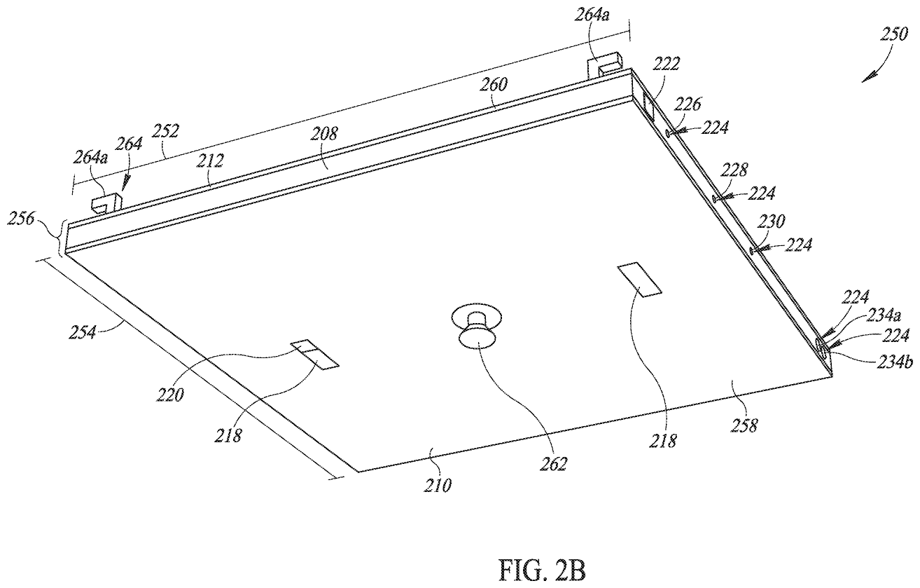

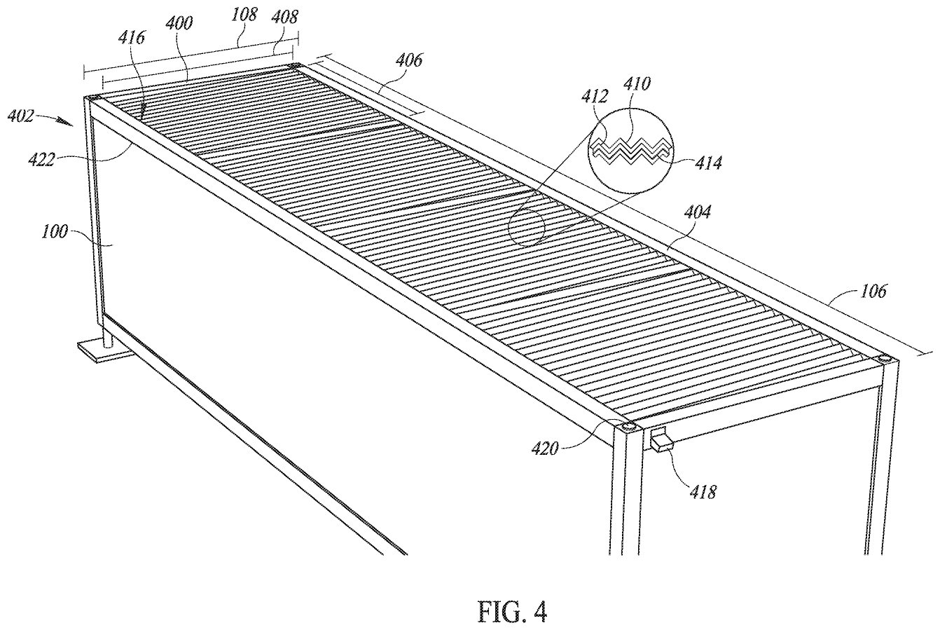

The connector 150 may include a post 166 that may be oriented in a vertical direction to be physically coupled to one of the vertical structural frame members 118a. In some implementations, the post 166 may be sized to be securely inserted into an opening 168 in the vertical structural frame member 118a. In some implementations, the vertical structural frame member 118a may include opposing sidewall apertures 162, and the post 166 may include a corresponding post aperture 170 that extends through the post 166. As such, the post 166 and the vertical structure frame member 118a may be selectively, releaseably physically secured to the connector 150 via the post 166. In some implementations, the posts 166 may be used to selectively, physically secure other structural members, such as modular ceiling panels (see FIG. 2B) and/or modular roof panels (see FIG. 4).

FIG. 2A shows a portion of a modular wall panel 200, according to at least one illustrated implementation. The modular wall panel 200 may have a length 202, a height 204, and a thickness 206. The modular wall panel 200 may include a rigid layer that may be used to support the modular wall panel 200 when the modular wall panel 200 is oriented in a vertical direction. The rigid layer may include, for example, a cold rolled steel layer 208. The cold rolled steel layer 208 may be formed of a rigid steel layer that may extend across the length 202 and/or height 204 of the modular wall panel 200. The cold rolled steel layer 208 may be of a sufficient thickness and associated rigidity to maintain the length 202 or the height 204 of the modular wall panel 200 oriented in a vertical direction 209. For example, in some implementations, the cold rolled steel layer 208 may be between 0.014 inches and about 0.25 inches, or more or less. In some implementation, such as those in which the modular wall panel 200 forms an exterior wall that may be subject to rain, snow, wind, or other elements, the cold rolled steel layer 208 may form an outside facing layer of the modular wall panel 200. In such an implementation, the cold rolled steel layer 208 may be treated with a protective layer to reduce the possibility that the cold rolled steel layer 208 may be adversely impacted by these or other weather elements, Such a treatment may be used to make the cold rolled steel layer 208 first resistant and/or water resistant. In some implementations, such as those in which the modular wall panel 200 is used within an interior portion 122 of the modular structure 100 (e.g., as an interior wall), the cold rolled steel layer 208 may be surrounded by other layers (e.g., an acoustic layer 210 and/or a thermal insulation layer 212). In some implementations, the modular wall panel 200 may be a pre-fabricated structural member such that the wall panel 200 is fabricated before reaching the site at which the modular wall panel 200 will be incorporated into one of the modular structures 100.

The modular wall panel 200 may include one or more layers. In some implementations, the modular wall panel 200 may include one or more of an acoustic layer 210 and/or a thermal insulation layer 212. One or both of the acoustic layer 210 and/or the thermal insulation layer 212 may extend across the length 202 and/or thickness 206 of the modular wall panel 200. In some implementations, each of the cold rolled steel layer 208, the acoustic layer 210, and/or the thermal insulation layer 212 may be oriented along substantially parallel planes. The acoustic layer 210 and/or the thermal insulation layer 212 may be physically attached to the cold rolled steel layer 208 using, for example, an adhesive such as one or more types of epoxy. The acoustic layer 210 and/or the thermal insulation layer 212 may be physically coupled to the cold rolled steel layer 208 using, for example, screw, bolts, or other physically couplers. In some implementations, one or more layers, coatings, and/or other treatments may provide protection to the modular wall panel 200. For example, such layers, coatings, and/or other treatments may make the modular wall panel 200 fire resistant, water resistant, and/or rot resistant.

For example, the modular wall panel 200 can employ, one, more or all of the components of an exterior insulation and finish system with drainage (EIFS). EIFS structures are generally a class of non-load bearing building cladding systems that provide exterior walls with an insulated, water-resistant, finished surface in an integrated composite material system, Also UN example, the modular wall panel 200 can employ, one, more or all of the components of an External Wall insulation System (EWIS) or External Thermal Insulation Cladding System (ETICS).

The acoustic layer 210 may be used to acoustically isolate or separate spaces on either side of the modular wall panel 200. Such an acoustic layer 210 may be included, for example, on a modular wall panel 200 that is incorporated into the interior portion 122 of the modular structure 100 to separate two different living areas. The acoustic layer 210 may be used to thereby prevent sounds in one of the living spaces from being heard in the other living space. The acoustic layer 210 may be comprised of material that absorbs energy from sound waves, such as foam, cardboard, Styrofoam, and/or insulation. The acoustic layer 210 may alternatively or additionally include one or more angled surfaces to reflect sound waves in a desired direction (e.g., away from the interior portion 122 or other living spaces of the modular structure 100).

The thermal insulation layer 212 may be used to reduce the transfer of thermal energy between areas on either side of the thermal insulation layer 212. In some implementations, the thermal insulation layer 212 may be located along an exterior wall of the modular structure 100 to prevent the transfer of thermal energy from the interior portion 122 of the modular structure 100 to the exterior during cold weather and to prevent the transfer from thermal energy from the exterior to the interior portion 122 of the modular structure 100 during warm weather. In some implementations, the thermal insulation layer 212 may be included as part of a modular wall panel 200 located in an interior portion 122 of the modular structure 100 to separate different living spaces. Such a thermal insulation layer 212 may be used to thereby prevent the transfer of thermal energy between the living spaces. Such an implementation may advantageously be used to separate spaces occupied by different occupants or tenants, such as may occur in an apartment or office. The thermal insulation layer 212 may be comprised of various types of material, such as, for example, fiberglass, cellulose, rock wool, cork, and foam.

The modular wall panel 200 may include a first primary surface 214 and an opposing second primary surface 216 separated by the thickness 206 of the modular wall panel 200. The modular wall panel 200 may include one or more sensors 218 (three shown in FIG. 2A). In some implementations, one or more of the sensors 218 may be integral to the modular wall panel 200, As such, the sensors 218 may be incorporated into modular wall panel 200 such that a surface of each respective sensor 218 may be flush or substantially flush with a plane formed by the first primary surface 214 and/or the second primary surface 216 of the modular wall panel 200. The sensor 218 may include one or more of water sensor 218a, a humidity sensor 218b, a temperature sensor 218c, a carbon monoxide sensor 218d, a smoke detector 218e, a passive infrared motion detector 218f, an image sensor 218a, a microphone 218h, an accelerometer 218i, an impact sensor 218j, a pressure sensor 218k, a load cell 218l, an air flow sensor 218m, a gas flow sensor 218n, a light detection and ranging (LIDAR) sensor 218o, and/or a radar sensor 218p (three sensors shown as sensors 218 in FIG. 2A). In some implementations, one or more of the sensors 218 may include a unique identifier 220 that may be used to identify each of the sensors 218. In some implementations, the unique identifier 220 may include, for example, a radio frequency identification (RFID) transponder 222c that may be used to encode the unique identifier. In some implementations, the unique identifier 220 may include a human readable symbol and/or a machine readable symbol (e.g., a barcode symbol and/or a Quick Response code symbol). In some implementations, one or more of the sensors may be communicatively coupled to a processor integrated into the modular wall panel 200 and/or to an off-site processor. As such, the sensor 218 may transmit signals representative of current or recent measurements to the processor. In such implementations, the sensor 218 may incorporate the unique identifier 220 in one or more of the transmissions that include the current or recent measurements. Such an implementation may advantageously be used to map the current and/or recent conditions to specific sensors 218 and associated locations.

In some implementations, the modular wall panel 200 may include one or more passages 224 that may be integral to the modular wall panel 200. In such implementations, the passages 224 within the modular wall panel 200 may be used to receive wired connections to one or more of the sensors 218 that are incorporated into the modular wall panel 200. In some implementations, such wired connections may include one or more of a wire 226, a cable 228. and/or an optical fiber 230. As such, one or more of the wire 226, the cable 228. and/or the optical fiber 230 may be used to communicatively couple one or more of the sensors 218 to a processor.

In some implementations, one or more of the wires 226 may be used to provide electrical power to one or more components within the modular wall panel 200. For example, in some implementations, the wire 226 may provide electrical power to one or more of the sensors 218 shown in FIG. 2A. Such sensors 218 may include, for example, the water sensor 218a, the humidity sensor 218b, the temperature sensor 218c, the carbon monoxide sensor 218d, the smoke detector 218e, the passive infrared motion detector 218f, the image sensor 218g, the microphone 218h, the accelerometer 218i, the impact sensor 218j, the pressure sensor 218k, the load cell 218l, the air flow sensor 218m, the gas flow sensor 218n, the light detection and ranging (LIDAR) sensor 218o, and/or the radar sensor 218p. In some implementations, one or more of the wires 226 may be used to provide electricity to at least one wired access connector 232. Such a wired access connector 232 may be integral to the modular wall panel 200, and may include one or more electrical receptacles that may be used to provide electricity to appliances with corresponding electrical plugs.

In some implementations, at least one or more of the passages 224 may include one or more fluid conduits 234 that may be used to transport one or more types of fluids. Such fluid conduits 234 may be integral to the modular wall panel 200. In some implementations, the modular wall panels may include multiple fluid conduits 234 (e.g., first fluid conduit 234a and second fluid conduit 234b) that may be used transport fluid for two separate fluid transport systems. For example, in some implementations, the first fluid conduit 234a may be used to transport clean water to supply water fixtures (e.g., sinks, wash tubs, etc.) in the modular structure 100, and the second fluid conduit 234b may be used to transport water (or a fire retardant fluid) for a sprinkler system that may be included within the modular structure 100. In such an implementation, the supply of fluid in one of the systems, such as the water for system that used the first fluid conduit 234a, may be selectively turned off, such as when an emergency occurs, whereas the supply of fluid in the second fluid conduit 234b may be maintained.

The modular wall panel 200 may include one or more unique identifiers 222 that may be used to uniquely identify each modular wall panel 200 from other modular wall panels 200, The unique identifiers 222 may include one or more of a human-readable symbol 222a, a machine-readable symbol 222b, and/or a radio frequency identification (RFID) transponder 222c that may be used to encode a unique identifier. The machine-readable symbol 222b may include one or more of a one-dimensional symbol (e.g., a barcode symbol) or a multi-dimensional symbol (e.g., a Quick Response (QR) code symbol) or some other type of machine-readable symbol.

In some implementations, the modular wall panels 200 may include one or more couplers 236 that may be used to couple the modular wall panel 200 to other modular wall panels 200 and/or to structure frame members 118 in the modular structure 100. In some implementations, for example, the modular wall panel 200 may include a tongue-and-groove coupling feature 236a that may be used to selectively, physically couple together adjacent modular wall panels 200, and/or to selectively, physically couple the modular wall panel 200 to one of the structural frame members 118. In some implementations, the modular wall panel 200 may include one or more posts 236b that may be selectively received by corresponding holes in adjacent modular wall panels 200 and/or by corresponding holes in one of the structural frame members 118. Other physical couplers could include one or more latches and/or a cam fitting that may be used to physically couple the modular wall panel 200 to other modular wall panels 200 and/or to one of the structural frame members 118. In such implementations, each of the modular wall panels 200 may be replaced as an integral unit, such as, for example, when the modular wall panel 200 becomes damaged.

FIG. 2B shows a portion of a modular ceiling panel 250, according to at least one illustrated implementation. The modular ceiling panel 250 may have a ceiling panel length 252, a ceiling panel width 254, and a ceiling panel thickness 256. The modular ceiling panel 250 may include a rigid layer that may be used to support the modular ceiling panel 250 when the modular ceiling panel 250 is oriented in a horizontal direction. The rigid layer may include, for example, the cold rolled steel layer 208. The cold rolled steel layer 208 may be formed of a rigid steel layer that may extend across the ceiling panel length 252 and/or the ceiling panel width 254 of the modular ceiling panel 250. For example, in some implementations, the cold rolled steel layer 208 may be between 0.014 inches and about 0.25 inches, or more or less. In some implementations, such as those in which the modular ceiling panel 250 is used within an interior portion 122 of the modular structure 100 (e.g., as an interior ceiling), the cold rolled steel layer 208 may be surrounded by other layers, such as an acoustic layer 210 and/or a thermal insulation layer 212 as discussed below. In some implementations, the modular ceiling panel 250 may be a pre-fabricated structural member such that modular ceiling panel 250 is fabricated before reaching the site at which the modular ceiling panel 250 will be incorporated into one of the modular structures 100.

The modular ceiling panel 250 may include one or more layers. In some implementations, the modular ceiling panel 250 may include one or more of an acoustic layer 210 and/or a thermal insulation layer 212. One or both of the acoustic layer 210 and/or the thermal insulation layer 212 may extend across the ceiling panel length 252 and/or ceiling panel width 254 of the modular ceiling panel 250. In some implementations, each of the cold rolled steel layer 208, the acoustic layer 210, and/or the thermal insulation layer 212 may be oriented along substantially parallel planes. The acoustic layer 210 and/or the thermal insulation layer 212 may be physically attached to the cold rolled steel layer 208 using, for example, an adhesive such as one or more types of epoxy. The acoustic layer 210 and/or the thermal insulation layer 212 may be physically coupled to the cold rolled steel layer 208 using, for example, screw, bolts, or other physically couplers. In some implementations, one or more layers, coatings, and/or other treatments may provide protection to the modular ceiling panel 250. For example, such layers, coatings, and/or other treatments may make the modular ceiling panel 250 fire resistant, water resistant, and/or rot resistant.

The acoustic layer 210 may be used to acoustically isolate or separate spaces on either side of the modular ceiling panel 250. Such an acoustic layer 210 may be included, for example, on a modular ceiling panel 250 that is incorporated into the interior portion 122 of the modular structure 100 to separate two different living areas. The acoustic layer 210 may be used to thereby prevent sounds in one of the living spaces from being heard in the other living space. The acoustic layer 210 may be comprised of material that absorbs energy from sound waves, such as foam, cardboard, Styrofoam, and/or insulation. The acoustic layer 210 may alternatively or additionally include one or more angled surfaces to reflect sound waves in a desired direction e.g., away from the interior portion 122 or other living spaces of the modular structure 100).

The thermal insulation layer 212 may be used to reduce the transfer of thermal energy between areas on either side of the thermal insulation layer 212. In some implementations, the thermal insulation layer 212 may be located along an exterior portion of the modular structure 100 to prevent the transfer of thermal energy from the interior portion 122 of the modular structure 100 to the exterior during cold weather and to prevent the transfer from thermal energy from the exterior to the interior portion 122 of the modular structure 100 during warm weather. In some implementations, the thermal insulation layer 212 may be included as part of a modular ceiling panel 250 located in an interior portion 122 of the modular structure 100 to separate different living spaces. Such a thermal insulation layer 212 may be used to thereby prevent the transfer of thermal energy between the living spaces. Such an implementation may advantageously be used to separate spaces occupied by different occupants or tenants, such as may occur in an apartment or office. The thermal insulation layer 212 may be comprised of various types of material, such as, for example, fiberglass, cellulose, rock wool, cork, and foam.

The modular ceiling panel 250 may include a first primary surface 258 and an opposing second primary surface 260 separated by the ceiling panel thickness 256 of the modular ceiling panel 250. The modular ceiling panel 250 may include one or more sensors 218 (three shown in FIG. 2A). In some implementations, one or more of the sensors 218 may be integral to the modular ceiling panel 250. As such, the sensors 218 may be incorporated into modular ceiling panel 250 such that a surface of each respective sensor 218 may be flush or substantially flush with a plane formed by the first primary surface 258 and/or the second primary surface 260 of the modular ceiling panel 250. The sensor 218 may include one or more of water sensor 218a, a humidity sensor 218b, a temperature sensor 218c, a carbon monoxide sensor 218d, a smoke detector 218e, a passive infrared motion detector 218f, an image sensor 218g, a microphone 218h, an accelerometer 218i, an impact sensor 218j, a pressure sensor 218k, a load cell 218l, an air flow sensor 218m, a gas flow sensor 218n, a light detection and ranging (LIDAR) sensor 218o, and/or a radar sensor 218p (three sensors shown as sensors 218 in FIG. 2A). In some implementations, one or more of the sensors 218 may include a unique identifier 220 that may be used to identify each of the sensors 218. In some implementations, the unique identifier 220 may include, for example, a radio frequency identification (RFID) transponder 222c that may be used to encode the unique identifier. In some implementations, the unique identifier 220 may include a human readable symbol and/or a machine readable symbol (e.g, a barcode symbol and/or a Quick Response code symbol). In some implementations, one or more of the sensors may be communicatively coupled to a processor integrated into the modular ceiling panel 250 and/or to an off-site processor. As such, the sensor 218 may transmit signals representative of current or recent measurements to the processor. In such implementations, the sensor 218 may incorporate the unique identifier 220 in one or more of the transmissions that include the current or recent measurements. Such an implementation may advantageously be used to map the current and/or recent conditions to specific sensors 218 and associated locations.

In some implementations, the modular ceiling panel 250 may include one or more passages 224 that may be integral to the modular ceiling panel 250. In such implementations, the passages 224 within the modular ceiling panel 250 may be used to receive wired connections to one or more of the sensors 218 that are incorporated into the modular ceiling panel 250. In some implementations, such wired connections may include one or more of a wire 226, a cable 228, and/or an optical fiber 230. As such, one or more of the wire 226, the cable 228, and/or the optical fiber 230 may be used to communicatively couple one or more of the sensors 218 to a processor.

In some implementations, one or more of the wires 226 may be used to provide electrical power to one or more components within the modular ceiling panel 250. For example, in some implementations, the wire 226 may provide electrical power to one or more of the sensors 218 shown in FIG. 2B. Such sensors 218 may include, for example, the water sensor 218a, the humidity sensor 218b, the temperature sensor 218c, the carbon monoxide sensor 218d, the smoke detector 218e, the passive infrared motion detector 218f, the image sensor 218g, the microphone 218h, the accelerometer 218i, the impact sensor 218j, the pressure sensor 218k, the load cell 218l, the air flow sensor 218m, the gas flow sensor 218n, the light detection and ranging (LIDAR) sensor 218o, and/or the radar sensor 218p. In some implementations, one or more of the wires 226 may be used to provide electricity to at least one wired access connector 232. Such a wired access connector 232 may be integral to the modular ceiling panel 250, and may include one or more electrical receptacles that may be used to provide electricity to appliances with corresponding electrical plugs.

In some implementations, at least one or more of the passages 224 may include one or more fluid conduits 234 that may be used to transport one or more types of fluids. Such fluid conduits 234 may be integral to the modular ceiling panel 250. In some implementations, the modular ceiling panel 250 may include multiple fluid conduits 234 (e.g., first fluid conduit 234a and second fluid conduit 234b) that may be used transport fluid for two separate fluid transport systems. For example, in some implementations, the first fluid conduit 234a may be used to transport clean water to supply water fixtures (e.g., sinks, wash tubs, etc.) in the modular structure 100, and the second fluid conduit 234b may be used to transport water (or a fire retardant fluid) for a sprinkler system that may be included within the modular structure 100. The second fluid conduit 234b may be used to provide fluid, such as water or some other flame retardant, to a sprinkler head 262 that may form an integral part of the ceiling panel 250. In such an implementation, the supply of fluid in one of the systems, such as the water for system that used the first fluid conduit 234a, may be selectively turned off, such as when an emergency occurs, whereas the supply of fluid in the second fluid conduit 234b may be maintained.

The modular ceiling panel 250 may include one or more unique identifiers 222 that may be used to uniquely identify each modular wall panel 200 from other modular ceiling panel 250. The unique identifiers 222 may include one or more of a human-readable symbol 222a, a machine-readable symbol 222b, and/or a radio frequency identification (RFID) transponder 222c that may be used to encode a unique identifier. The machine-readable symbol 222b may include one or more of a one-dimensional symbol (e.g., a barcode symbol) or a multi-dimensional symbol (e.g., a Quick Response (QR) code symbol) or some other type of machine-readable symbol.

In some implementations, the modular ceiling panel 250 may include one or more couplers 264 that may be used to couple the modular ceiling panel 250 to structure frame members 118 in the modular structure 100. In some implementations, for example, the modular ceiling panel 250 may include one or more posts 264a that may be selectively received by corresponding holes in one of the structural frame members 118. Other physical couplers could include one or more latches and/or a cam fitting that may be used to physically couple the modular ceiling panel 250 to other modular ceiling panel 250 and/or to one of the structural frame members 118. In such implementations, each of the modular ceiling panel 250 may be replaced as an integral unit, such as, for example, when the modular ceiling panel 250 becomes damaged.

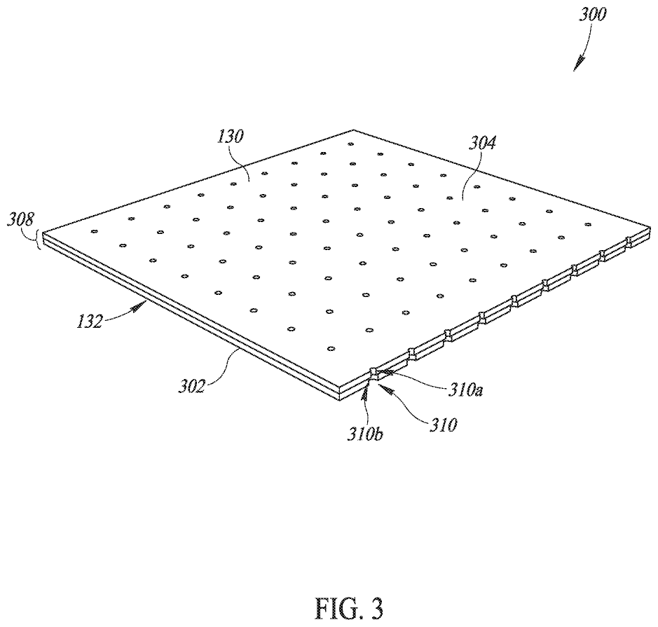

FIG. 3 shows a portion of a floor panel 300 that includes a first steel layer 302 and a non-metal layer 304 overlaying the first steel layer 302 in which perforations 306 extend through both the first steel layer 302 and the non-metal layer, 304 according to at least one illustrated implementation. The first steel layer 302 may have a width 308, and may extend across at least a portion of the length 106 and/or width 108 of the modular structure 100. The width 308 of the first steel layer 302 may be sufficient to support items and/or people located along the upper surface 130 of the floor 114. For example, the first steel layer 302 may be up to one-quarter inch thick, up to one-half inch thick, or more or less. The non-metal layer 304 may be any of a type of flooring surface that may be used in various types of living and/or working environments. In some implementations, flooring surface may be a natural or synthetic wood surface such as those that may be used for hardwood floors. In some implementations, the flooring surface used for the non-metal layer 304 may be comprised of one or more of a natural and/or synthetic padded surface, such as a carpet and/or a padded mat. Such a padded mat may include, for example, a carpet pad and/or an exercise mat.

The perforations 306 may extend from the upper surface 130 of the floor panel 300 to the lower surface 132 of the floor to thereby create a fluidly communicative path 310 that extends therethrough the floor panel 300 between the upper surface 130 and the lower surface 132 of the floor panel 300. Such a fluidly communicative path 310 may be of a size that will permit one or more types of fluids to be drained from the upper surface 130 of the floor panel 300 towards the gap 138 formed with the subfloor 102. In some implementations, the fluidly communicative path 310 may include two portions, a first portion 310a that extends through the non-metal layer 304. and a second portion 310b that extends through the first steel layer 302. In some such implementations, the first portion 310a of the fluidly communicative path 310 through the non-metal layer 304 may have a smaller cross-sectional area than the second portion 310b of the fluidly communicative path 310 that extends through the first steel layer 302. In such an implementation, the opening of the fluidly communicative path 310 on the upper surface 130 of the floor panel 300 may be less noticeable to occupants or others as compared to openings having a larger cross sectional area. In some implementations, the cross-sectional area of the first portion 310a of the fluidly communicative path 310 through the non-metal layer 304 may be the same or substantially the same size as the second portion 310b of the fluidly communicative path 310 that extends through the first steel layer 302. In some implementations, the first portion 310a of the fluidly communicative path 310 that extends through the non-metal layer 304 may be aligned with a corresponding second portion 310b of the fluidly communicative path 310 that extends through the first steel layer 302 to facilitate draining fluid from the upper surface 130 of the floor panel 300.

FIG. 4 shows a roof 400 that has been physically attached to the modular structure 100 proximate an upper portion 402 of the modular structure 100, according to at least one illustrated implementation. The roof 400 may include one or more modular roof panels 404 that may be physically coupleable to the structural frame members 118 of the modular structure 100. The modular roof panel 404 may include a modular roof panel length 406 and a modular roof panel width 408. Each modular roof panel 404 may include one or more layers, as shown in the cross-sectional view in FIG. 4. For example, in some implementations, each modular roof panel 404 may include a cold rolled steel layer 410 that may be formed of a rigid steel layer that may extend across some or all of the modular roof panel length 406 and/or modular roof panel width 408 of the modular roof panel 404. The cold rolled steel layer 410 may be of a sufficient thickness and associated rigidity to provide structural integrity for the roof 400 even during adverse weather (e.g., rainfall, hail, snow, or high winds). For example, in some implementations, the cold rolled steel layer 410 may be between 0.014 inches and about 0.25 inches, or more or less. In some implementation, the cold rolled steel layer 410 may be treated with a protective layer to reduce the possibility that the cold rolled steel layer 410 may be adversely impacted by these or other weather elements. Such a treatment may be used to make the cold rolled steel layer 410 first resistant and/or water resistant.

In some implementations, the modular roof panel 404 may include one or more of an acoustic layer 412 and/or a thermal insulation layer 414. One or both of the acoustic layer 412 and/or the thermal insulation layer 414 may extend fully or partially across the modular roof panel length 406 and/or the modular roof panel width 408 of the modular roof panel 404. In some implementations, each of the cold rolled steel layer 410, the acoustic layer 412, and/or the thermal insulation layer 414 may be substantially parallel to each other. The acoustic layer 412 and/or the thermal insulation layer 414 may be physically attached to each other and/or to the cold rolled steel layer 410 using, for example, an adhesive such as one or more types of epoxy. The acoustic layer 412 and/or the thermal insulation layer 414 may be physically coupled to each other and/or to the cold rolled steel layer 410 using, for example, screw, bolts, adhesives or other physically couplers. In some implementations, one or more layers, coatings, and/or other treatments may provide protection to the modular roof panel 404. For example, such layers, coatings, and/or other treatments may make the modular roof panel 404 fire resistant, water resistant, and/or rot resistant.

The acoustic layer 412 may be used to acoustically isolate or separate the interior portion 122 of the modular structure 100 from the exterior 124. The acoustic layer 412 may be comprised of material that absorbs energy from sound waves, such as foam, cardboard, Styrofoam, and/or insulation. The acoustic layer 412 may alternatively or additionally include one or more angled surfaces to reflect sound waves in a desired direction (e.g., away from the interior portion 122 or other living spaces of the modular structure 100). The thermal insulation layer 414 may be used to reduce the transfer of thermal energy between the interior portion 122 of the modular structure 100 and the exterior 124 to prevent the transfer of thermal energy from the interior portion 122 of the modular structure 100 to the exterior during cold weather and to prevent the transfer from thermal energy from the exterior to the interior portion 122 of the modular structure 100 during warm weather). The thermal insulation layer 414 may be comprised of various types of material, such as, for example, fiberglass, cellulose, rock wool, cork, and foam.

The roof 400 may be tilted to facilitate draining rain water, snow melt, or other fluids that may be introduced to the roof 400. In some implementations, the roof 400 may tilt relatively downwards when the roof 400 is traversed from a first edge of the modular structure 100 towards a second, opposing edge of the modular structure 100. In such an implementation, for example, the roof 400 may tilt such as to drain fluids along the width 108 of the modular structure 100 so that the direction of travel of the fluid is along the width 108 of the modular structure 100. By draining along the shorter edge of the modular structure, the rise of the roof 400 due to the tilt may be kept relatively lower as compared to draining the fluid along the relatively longer length 106. In some implementations, the roof 400 may include one or more ceiling channels 416 that may be used to collect the draining fluid along a respective edge of the roof 400. In such an implementation, the ceiling channel 416 may be sloped to drain the fluid towards a scupper 418 that may provide a fluidly communicative exit path for the fluid to exit the upper surface of the roof 400.

The modular roof panels 404 may include one or more anchor points 420 that may be used to selectively, physically couple the modular roof panels 404 to other structural member of the modular structure 100. For example, in some implementations, the one or more anchor points 420 may physically couple the respective modular roof panel 404 to one or more of the structural frame members 118 (e.g., upper horizontal structural frame members 118c. The one or more anchor points 420 may be physically coupled to the modular structure 100 using one or more types of physical couplers, such as, for example, nuts and bolts, rivets, anchoring pins, or other similar such physical couplers. In some implementations, a rubber or silicone seal or gasket 422 may be interposed between the modular roof panel 404 and the other structural member(s) of the modular structure 100 to which the modular roof panel 404 is attached. Such a rubber or silicone seal or gasket 422 may be used to provide an air-tight and/or waterproof seal between the roof 400 and the other portion of the modular structure 100. Although FIG. 4 is depicted with a parapet design, other types of ceiling outlines may be used for the roof 400, such as a saw-toothed clerestory outline and/or a gabled outline.

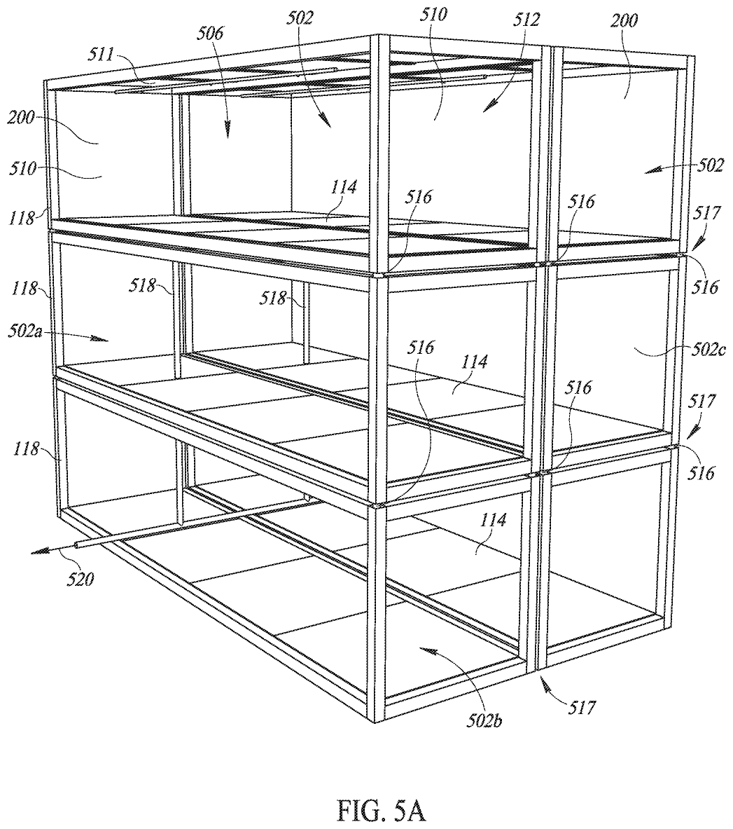

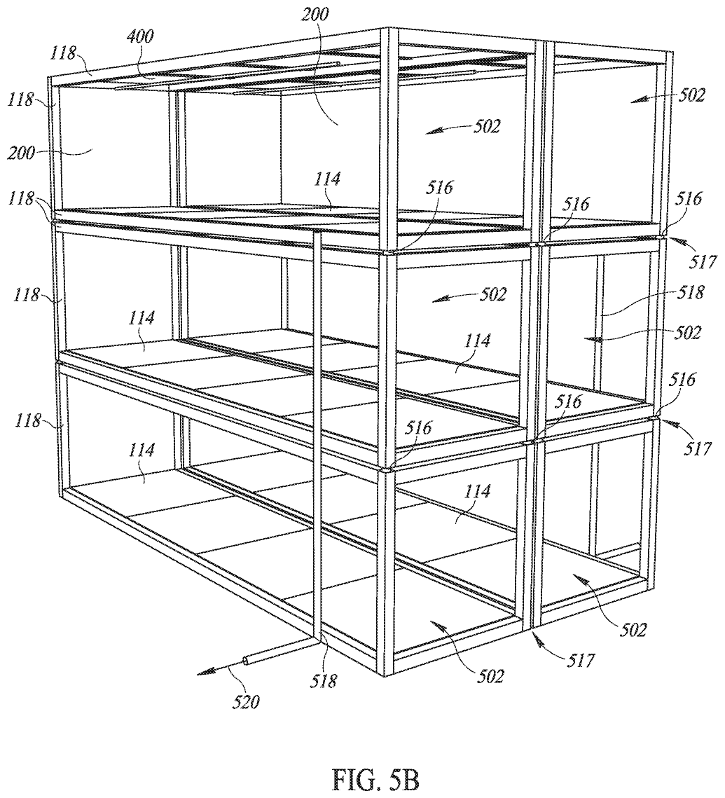

FIGS. 5A and 5B show modular buildings 500 comprised of a plurality of modular dwelling units 502, each of which is physically coupled to one or more adjacent modular dwelling units 502, in which fluid drains through one or more fluidly communicative paths 504 located towards a center portion 506 of each modular dwelling unit (FIG. 5A), or through one or more fluidly communicative paths 504 located towards a perimeter 508 of the modular building 500 (FIG. 5B), according to at least one illustrated implantation. Each of the modular dwelling units 502 may be comprised of a modular structure 100 with one or more modular wall panels 200, floors 114 and subfloors 102, and/or modular ceiling panels 250. The modular wall panels 200 may be used to form one or more perimeter walls 510. The perimeter walls 510 along with the floor 114 and a ceiling 511, may delimit a respective interior 512 of the modular dwelling unit 502, thereby separating the respective interior 512 from an exterior 514. In some implementations, one or more of the perimeter walls 510 may be load bearing. The floor 114 may be comprised of a plurality of floor panels 300. The ceiling 511 may be comprised of a plurality of ceiling panels 250. In such an implementation, the perimeter walls 510 may be physically coupled to one or more structural frame members 118.

In some implementations, the modular dwelling units 502 may be arranged as an array of modular dwelling units 502. As such, the modular dwelling units 502 may be arranged within certain number of rows and columns. In other implementations, the modular dwelling units 502 can be arranged in any number of configurations. In such implementations, each modular dwelling unit 502 may be physically coupled to one or a number of nearest neighboring modular dwelling units 502 via one or more physical couplers 516. Such physical couplers 516 may include one or more of a nut and bolt, a latch, or some other type of physical coupler 516. In some such implementations, a gap 517 may exist between neighboring modular dwelling units 502. In such implementations, at least one of the modular dwelling units 502, such as first modular dwelling unit 502a, may be spaced above an adjacent modular dwelling unit 502 (e.g., the first modular dwelling unit 502a is spaced above a second modular dwelling unit 502b) and may be spaced laterally from another modular dwelling unit 502 (e.g., the first modular dwelling unit 502a is spaced laterally from a third modular dwelling unit 502c).

The gap 138 between the floor 114 and subfloor 102, the conduit 140, and/or sealing system 148 for each modular dwelling unit 502 may be used to fluidly isolate the modular dwelling unit 502 from adjacent modular dwelling units 502. In some implementations, fluid that is incident upon the floor 114 in one modular dwelling unit 502 may thereby drain towards the associate subfloor 102 in the same modular dwelling unit 502. The fluid may thereby collect in the respective gap 138 between the floor 114 and subfloor 102 for the modular dwelling unit 502. The fluid in the gap 138 may drain towards a channel 144 located along the respective interior 512 of the modular dwelling unit 502 (FIG. 5A) or towards a channel 144 located proximate the exterior 514 of the modular dwelling unit 502 (FIG. 5B). Each respective channel 144 may be fluidly communicatively coupled to the conduit 140, which may be fluidly communicatively coupled to a fluidly communicative drainage channel 518 that may provide a fluid path 520 for the fluid to drain from the subfloor 102 of the respective modular dwelling unit 502 to the exterior 514. In some implementations, the fluidly communicative drainage channel 518 may be comprised of a cylindrical tube that may be comprised of a corrosion resistant metal and/or non-metal substance (e.g., PVC or some other synthetic material). The fluidly communicative drainage channel 518 may be fluidly coupled to the conduits 142 in a plurality of subfloors 102 from a corresponding plurality of modular dwelling units 502. Such a fluidly communicative drainage channel 518 may thereby collect fluid from the plurality of modular dwelling units 502 and drain such fluids away from the modular building 500.

In some implementations, one or more of the modular dwelling units 502 may include a set of sensors 218 that may be used to monitor the physical environment within the respective modular dwelling unit 502. Such sensors 218 may be an integral part of one or more of the modular wall panels 200 and/or the modular ceiling panels 250. Such sensors 218 may include, for example, one or more of the water sensor 218a, the humidity sensor 218b, the temperature sensor 218c, the carbon monoxide sensor 218d, the smoke detector 218e, the passive infrared motion detector 218f, the image sensor 218g, the microphone 218h, the accelerometer 218i, the impact sensor 218j, the pressure sensor 218k, the load cell 218l, the air flow sensor 218m, the gas flow sensor 218n, the light detection and ranging (L1DAR) sensor 218o, and/or the radar sensor 218p. Such sensors 218 may be used alternatively and/or additionally to monitor physical characteristics of or other data related to an occupant or inhabitant 522 of the modular dwelling unit 502.

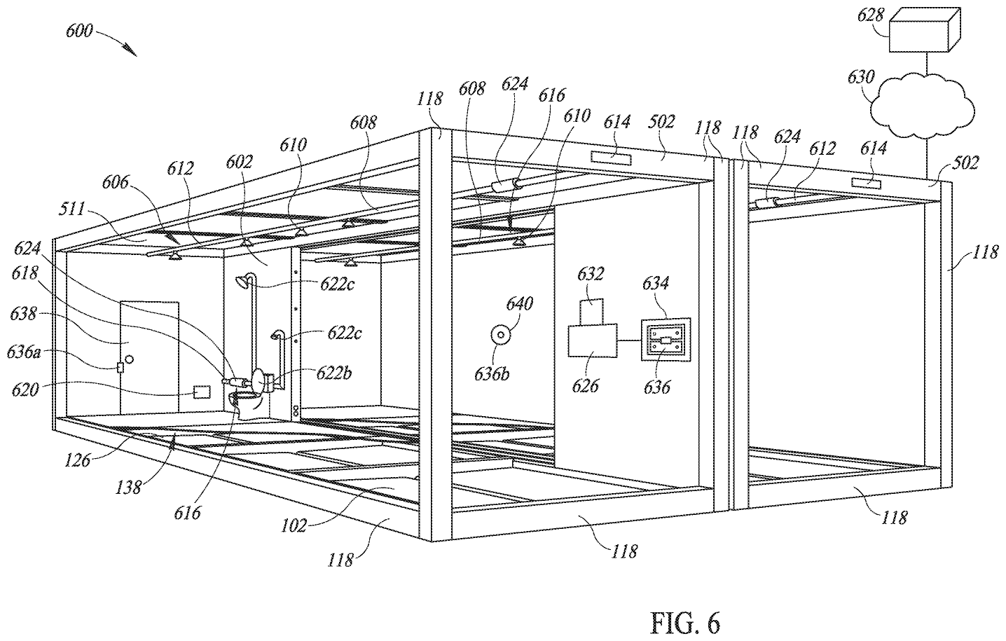

FIG. 6 shows a modular building 600 comprised of two adjacent modular dwelling units 502 with a modular wall 602 placed along an interior portion 604 of the modular building 600, according to at least one illustrated implementation. The modular wall 602 may be load bearing. Each modular dwelling unit 502 includes a first supply network 606 that is fluidly coupled to supply water or other fluid to a sprinkler system 608 that may include one or more sprinkler heads 610 located proximate the ceiling 511 of the modular dwelling units 502, sprinkler pipes 612 that may fluidly couple the sprinkler heads 610 to a source of fluid, and one or more first supply valves 614 that may be used to control the flow of fluid to respective ones of the sprinkler heads 610. In some implementations, the sprinkler pipes 612 may be located inside of, and may be an integral portion of, the modular ceiling panels 250 that may be used to form the ceiling 511. In some implementations, the first supply valve 614 may be located within the ceiling 511 (e.g., inside of, or forming an integral portion of, one of the ceiling panels 250), and/or within one of the other structural members of the modular dwelling unit 502, such as one of the frame members 118. Such a first supply valve 614 may be selectively operable to control a flow of water or other fluid into the sprinkler pipes 612 and the associated modular dwelling unit 502.

The modular building 600 may include a second supply network 616 that may be fluidly coupled to a water source, and may carry water or other fluids in one or more pipes 618 located proximate and/or within the modular wall 602. The second supply network 616 may further include a second supply valve 620 that may be used to control the flow of water through the second supply network 616. In some implementations, the second supply network 616 may include one or more fittings that may be coupled to water using components for individuals or occupants of the modular building 600. Such water using components may include, for example, a faucet 622a, a toilet 622b, and/or a showerhead 622c. In some implementations, each water-using component or a flow or volume meter attached thereto may generate a signal when in use. The second supply valve 620 may be selectively operable to permit or to stop a flow of water through the second supply network 616 for the water using components. In some implementations, one or both of the first fluid network 606 and/or the second supply network 616 may include one or more flow meters 624 that may be used to detect the flow of fluid through the respective fluid networks. Such flow meters 624 may produce an electrical signal that indicates that fluid is flowing through the associated fluid network. In some implementations, the electrical signal provided by the flow meter 624 may be used to indicate the rate of flow of the fluid within the associated fluid network.

The modular building 600 may include one or more circuit boards 626 that may be integral to one or more structural members, such as the modular wall 602 as shown in FIG. 6. The circuit board 626 may be electrically coupled to one or more of the sensors 218 that may be incorporated into the modular dwelling units 502. The circuit board 626 may additionally and/or alternatively be electrically coupled to one or more actuators and/or valves (e.g., first supply valve 614 and/or second supply valve 620) that may be used to control systems and/or components within the modular dwelling units 502. In some implementations, such electrical coupling may occur through one or more electrical wires, cables, or fiber optics (not shown) that may be run through one or more passageways that are integral to one or more structural members (e.g., frame members 118, modular ceiling panels 250, modular wall panels 200) of the modular dwelling units 502. In such implementations, the circuit board 626 may receive electrical signals from the sensors 218, and based upon such signals, transmit one or more control signals to control the operation and/or state of the actuators and/or valves. In some implementations, the circuit board 626 may be communicatively coupled to sensors 218, valves, and/or actuators in a plurality of modular dwelling units 502, such as may occur, for example, in a modular building 500 that includes a plurality of modular dwelling units 502. In such an implementation, the circuit board 626 may control the valves and/or actuators for each of the modular dwelling units 502 based upon the signals received from the respective sensors 218 for that modular dwelling unit 502.

In some implementations, the circuit board 626 may be communicatively coupled to a remote cloud-based monitoring system 628 via a communications network 630 and a communications hub 632. In such an implementation, the circuit board 626 may transmit the signals received from the one or more sensors 218 in the modular dwelling unit 502 and may receive one or more control signals from the remote cloud-based monitoring system 628 to control an action and/or state for one or more of the actuators and/or valves in the modular dwelling unit 502. The circuit board 626 may be communicatively coupled via one or more of a wired and/or wireless connection or protocol (e.g., Ethernet, Wi-Fi, ZigBee, Z-Wave). The communications network 630 may include various types of networks such as: a PSTN (public switched telephone network), the Internet, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced intelligent Network (AIN) connection, a synchronous optical network (SONET) connection, a digital T1, T3, E1 or E3 line, a Digital Data Service (DDS) connection, a DSL (Digital Subscriber Line) connection, an Ethernet connection, an ISDN (Integrated Services Digital Network) line, a dial-up port such as a V.90, V.34, or V.34bis analog modem connection, a cable modem, an ATM (Asynchronous Transfer Mode) connection, or an FDDI (Fiber Distributed Data Interface) or CDDI (Copper Distributed Data Interface) connection.

In some implementations, the circuit board 626 may transmit one or more control signals in response to receiving an indication that a leak is occurring within the modular dwelling unit 502. Such an indication may occur, for example, based upon signals received from one or more sensors 218 and/or flow meters 624. For example, in some implementations, the circuit board 626 may receive a signal from the flow meter 624 associated with the second supply network 616 indicating that water is flowing through the second supply network 616, even though none of the water using components (e.g., the faucet 622a, the toilet 622b, and the showerhead 622c) indicate that they are in use. In such a situation, the circuit board 626 may determine that a leak is occurring within the second supply network 616. In this situation, the circuit board 626 may generate and transmit a control signal for the second supply valve 620 associated with the second supply network 616 indicating that the second supply valve 620 should move to the OFF state to stop the flow of water through the second supply network 616. In some situations, the circuit board 626 may receive an alert signal from a liquid sensor 146 (FIG. 1A) located in the gap 138 between the floor 114 and the subfloor 102 in which the alert signal indicates the presence of fluid in the gap 138. In such a situation, the circuit board 626 may be responsive to the alert signal to transmit control signals that result in one or both of the first supply valve 614 or the second supply valve 620 that control the first supply network 606 and the second supply network 616. respectively, moving to the OFF state to stop the flow of water or other fluid through the first supply network 606 and/or the second supply network 616.

In some implementations, the modular dwelling unit 502 may have one or more actuators 636 (two shown, a lock actuator 636a and an alarm actuator 636b). In such implementations, the actuators 636 may be responsive to a control signal to switch between an ON and an OFF state and/or an ACTIVATED and a DEACTIVATED state. For example, in implementations including the lock actuator 636a, a control signal may be received by the lock actuator 636a to move between an ON/LOCKED state and an OFF/UNLOCKED state. As such, the door actuator 636a may be activated, and a door 638 associated with the lock actuator 636a may be locked by transmitting an appropriate control signal to the lock actuator 636a. In implementations that have an alarm actuator 636b, an alarm 640 associated with the alarm actuator 636b may be activated to generate an alarm signal (e.g., a loud noise and/or flashing fight) in response, for an example, to an emergency condition existing in the modular dwelling unit 502. In some implementations, the alarm condition may be recognized and the alarm signal triggered based upon one or more signals generated by the sensors 218 in the modular dwelling unit 502.

In some implementations, the circuit board 626 may be communicatively coupled to a display 634 that may be used to receive commands from an occupant or inhabitant of the modular dwelling unit 502. In such an implementation, the display 634 may be used to render a dashboard (i.e., a visual representation of various conditions or parameters, discussed below) to provide conditions related to the modular dwelling unit 502 and/or to receive input and commands from the occupant or inhabitant. In such implementations, the dashboard may be used to receive a human generated command, such as may be received by the occupant or inhabitant of the modular dwelling unit 502. Such commands may result, for example, in changing the state or condition of one or more of the actuators 636 in the modular dwelling unit 502 and/or may result in one or both of the first supply valve 614 and/or the second supply valve 620 being moved to the OFF position or the ON position to stop or start, respectively, the flow of water or other fluid through the first supply network 606 and/or the second supply network 616, respectively. In some implementations, the dashboard may be rendered on a device that is located remoted from the modular dwelling unit 502, such as at a remote monitoring facility. In some implementations, the dashboard may be rendered on a device (e.g., a smartphone or tablet computer) that is associated with the occupant or inhabitant of the modular dwelling unit 502.

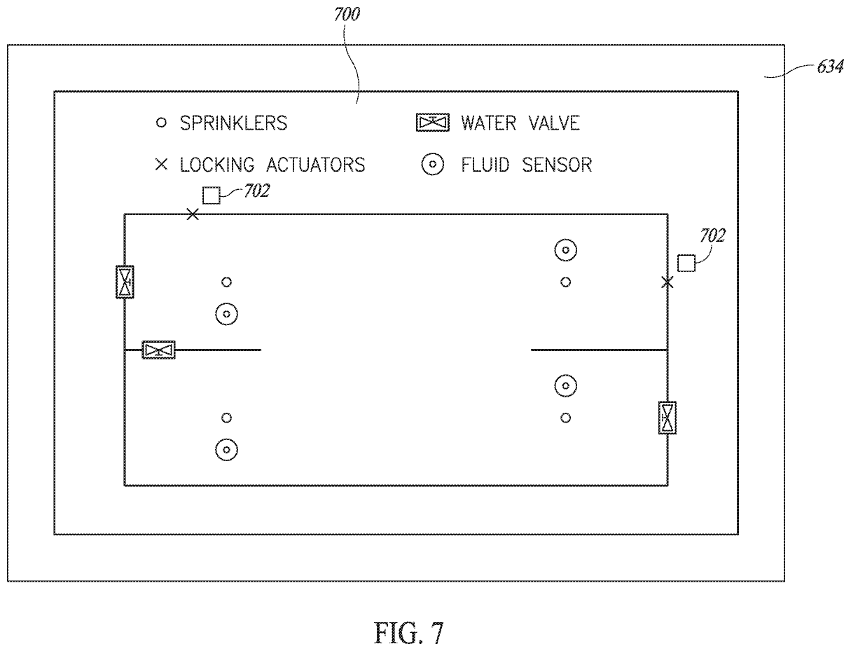

FIG. 7 shows a dashboard 700 that displays information related to one or more modular dwelling units 502. The dashboard 700 may be rendered at the display 634 that is located within a modular dwelling unit 502 that is being monitored, and/or the dashboard 700 may be rendered on a device located remotely from the modular dwelling unit 502 being monitored. The dashboard 700 may present various views of the modular dwelling unit 502, including views that may be captured from one or more image capture devices (e.g., cameras) located within or proximate to the modular dwelling unit 502. In such implementations, the image capture devices may be orientable to capture images that include one or more of the sensors 218 located within the modular dwelling unit 502 and/or one or more of the actuators or valves located within the modular dwelling unit 502. In some implementations, the dashboard 700 may present a plan view representation of the modular dwelling unit 502. As such, the dashboard 700 may be used to represent physical characteristics of the modular dwelling unit 502 based, for example, on the signals received from one or more of the sensors 218 in the modular dwelling unit 502. The dashboard 700 may additionally or alternatively be used to represent sensed physical characteristics of any inhabitants of the modular dwelling unit 502. In some implementations, the dashboard 700 may be used to indicate alarm events that may be generated at one or more of the sensors 218. The dashboard 700 may alternatively or additionally be used to generate one or more control signals that may be transmitted to one or more of the actuators and/or valves in the modular dwelling unit 502. For example, in some implementations, the dashboard 700 may include one or more user interactive inputs 702 that may be operable to receive inputs from a user. Such inputs, for example, may be used to activate and/or deactivate one or more of the actuators 636 in the modular dwelling unit 502.

The dashboard 700 may be rendered on devices at various locations. For example, in some implementations, the dashboard may be displayed on a device that is located within the modular dwelling unit 502 being monitored (see FIG. 6). In some implementations, dashboards 700 associated with a plurality of modular dwelling units 502 may be displayed on a single device. In some such implementations, for example, the display device may depict dashboards 700 from each of the plurality of the modular dwelling units 502 located in the modular building 500. As such, the dashboard 700 may be presented only to an authorized user, such as an authorized building monitor or manager associated with the modular building 500. In some such implementations, the authorized building monitor or manager may access the dashboard 700 only after identity authentication process, such as, for example, entering a secure pass code or engaging a biometric scan. In some implementations, the dashboard 700 may be used to present information about some other modular dwelling unit 502 other than the modular dwelling unit 502 in which the display for the dashboard 700 is located. As such, for example, the dashboard 700 may be used to depict and alert occupants of an emergency situation (e.g., fire or medical emergency) in a nearby modular dwelling unit 502. In some implementations, the dashboard 700 may be depicted on a device, such as a mobile device, associated with the inhabitant and/or occupant of the modular dwelling unit 502. In some implementations, the dashboard 700 may be depicted on a device, such as a computer display or mobile device, associated with a caseworker (e.g., a social worker) associated with one of the inhabitants or occupants of the modular dwelling unit 502.

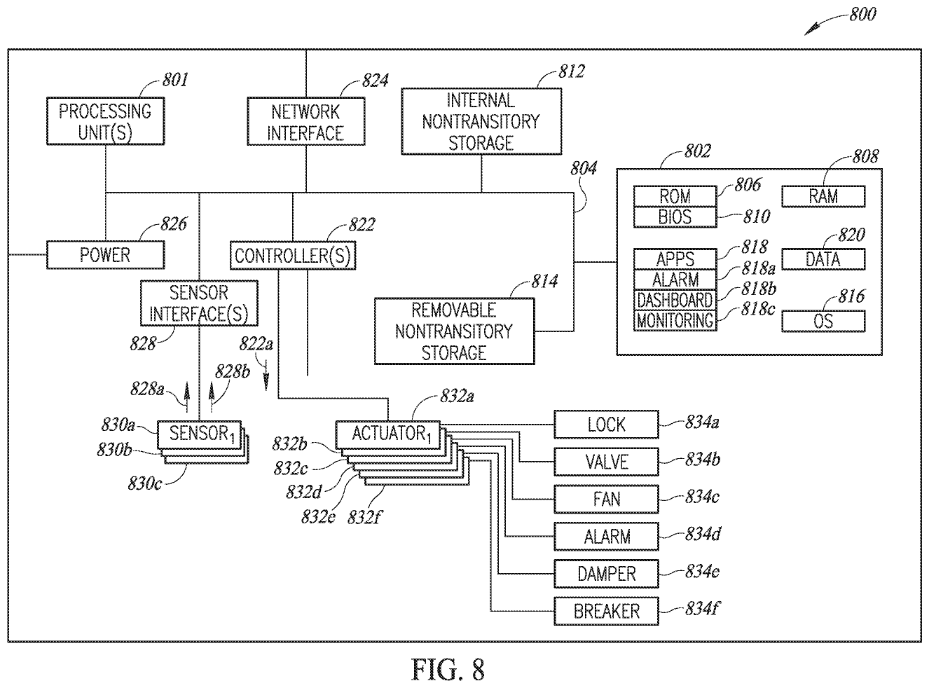

FIG. 8 is a schematic diagram showing a processor-based system 800 that may be used to receive signals from one or more sensors 218, generate control signals to control operation of one or more actuators, for instance to control locks, valves, and/or produce an alarm signal (e.g., aural, visual, electronic) based on one or more criteria, according to at least one illustrated implementation. Although the processor-based system 800 may be described herein as a functional element, one of ordinary skill in the art would readily appreciate that some or all of the functionality may be performed using one or more additional computing devices which may be external to the processor-based system 800. Such computing devices may be included, for example, within a networked environment. The processor-based system 800 may implement some or all of the various functions and operations discussed herein.

Although not required, some portion of the specific implementations will be described in the general context of computer-executable instructions or logic, such as program application modules, objects, or macros being executed by a computer. Those skilled in the relevant art will appreciate that the illustrated embodiments as well as other embodiments can be practiced with other computer system configurations, including handheld devices for instance Web enabled cellular phones or PDAs, multiprocessor systems, microprocessor-based or programmable consumer electronics, personal computers (“PCs”), network PCs, minicomputers, mainframe computers, and the like. The implementations can be practiced in distributed computing environments where tasks or modules are performed by remote processing devices, such as the remote cloud-based monitoring system 628, which are linked through a communications network, such as the communications network 630. In a distributed computing enviromnent, program modules may be stored in both local and remote memory storage devices and executed using one or more local or remote processors, microprocessors, digital signal processors, controllers, or combinations thereof.

The processor-based system 800 may take the form of any current or future developed computing system capable of executing one or more instruction sets. The processor-based system 800 includes one or more processing units 801, a system memory 802, one or more controllers 822 (only one illustrated), a network interface 824, a power module 826, one or more sensor interfaces 828 (only one illustrated) and a system bus 804 that communicably couples various system components including the system memory 802 to the processing unit(s) 801. The processor-based system 800 will at times be referred to in the singular herein, but this is not intended to limit the embodiments to a single system, since in certain embodiments, there will be more than one system or other networked computing device involved. Non-limiting examples of commercially available systems include, but are not limited to, an Atom, Pentium, or 80×86 architecture microprocessor as offered by Intel Corporation, a Snapdragon processor as offered by Qualcomm, Inc., a PowerPC microprocessor as offered by IBM, a Sparc microprocessor as offered by Sun Microsystems, Inc., a PA-RISC series microprocessor as offered by Hewlett-Packard Company, an A6 or A8 or A12 series processor as offered by Apple Inc., or a 68xxx series microprocessor as offered by Motorola Corporation.

The processing unit(s) 801 may be any logic processing unit or circuit (e.g., integrated circuit, analog circuit), such as one or more central processing units (CPUs), microprocessors, digital signal processors (DSPs), application-specific integrated circuits (ASICs), field programmable gate arrays (FPGAs), programmable logic controllers (PLCs), and/or graphics processing units (GPUs), etc. In some implementations, the processing unit(s) 801 may be communicatively coupled to one or more controllers 822, for instance one or more microcontrollers (e.g., motor controllers), that provide signals to control one or more of actuators 832a, 832b, 832c, 832d, 832e, 832f (only three six, collectively 832) to control various mechanisms (e.g., locks 834a, valves 834b, fans 834c, alarms 834d, dampers 834e, circuit breakers 834f) at the various modular dwelling units 502.

Notably, each various modular dwelling units 502 may have a set of controllable mechanism, including one or more locks 834a, one or more valves 834b, one or more fans 834c, one or more alarms 834d, one or more dampers 834e, and/or one or more circuit breakers 834f, which operable via respective actuators 832a-832f in response to control signals provided by the processor-based system 804. The processor-based system 804 may, for example, control the mechanisms for a particular modular dwelling unit 502 based, at least in part on, sensed information, for instance information sensed by sensors in or at the respective modular dwelling unit 502. The processor-based system 804 may, for example, control the mechanisms for group of modular dwelling units 502 together, based, at least in part on, sensed information, for instance information sensed by sensors in or at one or more of the modular dwelling units 502. The processor-based system 804 may, for example, control the mechanisms for all of modular dwelling units 502 together, based, at least in part on, sensed information, for instance information sensed by sensors in or at one or more of the modular dwelling units 502. Sensed information may include information sensed by, for example, smoke detectors, carbon monoxide detectors, water detectors, moisture detectors, temperature detectors, glass-breakage detectors, motion detectors, passive infrared detectors, contact switches, magnetic switches, etc., as well as information about an operational state or condition (e.g., open, closed, stuck, responsive, non-responsive) of one or more of the actuators 832. Additionally or alternatively, the processor-based system 804 may, for example, control the mechanisms for a particular modular dwelling unit 502, for group of modular dwelling units 502 together, or for all of modular dwelling units 502 together based, at least in part on, selections or other input received via dashboard 700 or other user input device which selections or inputs may, or may not, be independent of sensed information sensed by the sensors.

The system bus 804 can employ any known bus structures or architectures, including a memory bus with memory controller, a peripheral bus, and a local bus. The system memory 802 includes read-only memory (“ROM”) 806 and random access memory (“RAM”) 808. A basic input/output system (“BIOS”) 810, which can form part of the ROM 806, contains basic routines that help transfer information between elements within the processor-based system 800, such as during start-up. Some implementations may employ separate buses for data, instructions and power.

The processor-based system 800 may include one or more controllers 822 that may generate and transmit one or more control signals to the actuators 832 in or at one or more of the modular dwelling units 502. The controller(s) 822 may be communicatively coupled and operable to transmit one or more signals 822a to one or more actuators e.g., electric motors, stepper motors, solenoids, pumps, pneumatic or hydraulic cylinders and pistons, shape memory alloy elements, and/or other actuators) that may be used to control the movement of such motors, solenoids, pumps, pistons, and/or other actuators. Such movement may be used to selectively extend and/or retract a latch or other locking mechanism (e.g., key strike lock, electric strike lock, deadbolt lock, knob locks, lever locks, cylinder locks, smart locks), for example in the event of a disturbance or other occurrence either in or outside of a modular dwelling unit 502 or in the vicinity thereof. Such may allow easy ingress by first responders to the modular dwelling unit 502 in the event of an emergency, or may secure the modular dwelling unit 502 from intruders in the event of an external disturbance. Such movements may be used to selectively activate and/or deactivate a pump, heater, cooling device, fan, blower, damper, or other machine associated with the actuator. Such may be used to close access ways to prevent the spread of fire and/or smoke in the event of an emergency, or to distribute water or fire retardant in the event of a fire. Such may also be used to remove liquid (e.g., water) the event or a leak or spill. Such movement may be used to selectively open and close one or more valves, for example closing a valve on a main water line in response to detection of a leak or presence of liquid above a threshold amount in a space or location in a modular dwelling unit 502 where liquid should not collect or in a location (e.g., sump, channel, conduits 140) built to collect liquid in the event of a spill or leak. Such may additionally cause presentation of an alarm, for example an aural (e.g., klaxon, siren) or visual (e.g., strobe light, flashing lights) alert in the event of a disturbance or emergency. In some implementations, the controller 822 may include one or more microcontrollers that may be used to generate the signals 822a used to activate and/or control the one or more motors, solenoids, pumps, pneumatic or hydraulic cylinders and pistons, and/or other actuators. In some implementations, the one or more microcontrollers may be part of or located proximate to the respective motor, piston, and/or other actuator being controlled.

In some embodiments, the processor-based system 800 operates in an environment using one or more of the network interfaces 824 to optionally communicably couple to one or more remote computers, servers, display devices, and/or other devices via one or more communications channels. The one or more communications channels may be provided, at least in part, for example, via the communications network 630, These logical connections may facilitate any known method of permitting computers to communicate, such as through one or more LANs and/or WANs. Such networking environments are well known in wired and wireless enterprise-wide computer networks, intranets, extranets, and the Internet.

The processor-based system 800 may include a sensor interface 828. Such a sensor interface 828 may be communicatively coupled with, and may receive signals from, one or more sensors 218. The sensor 218 may include one or more of the water sensor 218a, the humidity sensor 218b, the temperature sensor 218c, the carbon monoxide sensor 218d, the smoke detector 218e, the passive infrared motion detector 218f, the image sensor 218g, the microphone 218h, the accelerometer 218i, the impact sensor 218j, the pressure sensor 218k, the load cell 218l, the air flow sensor 218m, the gas flow sensor 218n, the light detection and ranging (LIDAR) sensor 218o, and/or the radar sensor 218p. In some implementations, the sensor interface 828 may receive signals from the flow meter 624. Such signals may be used by the processor-based system 800 to identify conditions that may meet one or more criteria for generating an alarm signal.

The processor-based system 800 also includes one or more internal nontransitory storage systems 812. Such internal nontransitory storage systems 812 may include, but are not limited to, any current or future developed persistent storage device. Such persistent storage devices may include, without limitation, magnetic storage devices such as hard disc drives, electromagnetic storage devices such as memristors, molecular storage devices, quantum storage devices, electrostatic storage devices such as solid state drives, and the like.

The processor-based system 800 may also include one or more optional removable nontransitory storage systems 814. Such removable nontransitory storage systems 814 may include, but are not limited to, any current or future developed removable persistent storage device. Such removable persistent storage devices may include, without limitation, magnetic storage devices, electromagnetic storage devices such as memristors, molecular storage devices, quantum storage devices, and electrostatic storage devices such as secure digital (“SD”) drives, USB drives, memory sticks, or the like.

The one or more internal nontransitory storage systems 812 and the one or more optional removable nontransitory storage systems 814 communicate with the processing unit 801 via the system bus 804. The one or more internal nontransitory storage systems 812 and the one or more optional removable nontransitory storage systems 814 may include interfaces or device controllers (not shown) communicably coupled between nontransitory storage system and the system bus 804, as is known by those skilled in the relevant art. The nontransitory storage systems 812, 814, and their associated storage devices provide nonvolatile storage of computer-readable instructions, data structures, program modules and other data for the processor-based system 800. Those skilled in the relevant art will appreciate that other types of storage devices may be employed to store digital data accessible by a computer, such as magnetic cassettes, flash memory cards, RAMs, ROMs, smart cards. etc.

Program modules can be stored in the system memory 802, such as an operating system 816, one or more application programs 818, and program data 820.

The application programs 818 may include, for example, one or more machine executable instruction sets (i.e., alarm module 818a) capable of generating an alarm signal based on input received from one or more sensors 218 and/or flow meter 624. The application programs 818 may additionally include one or more machine executable instruction sets (i.e., dashboard 818b) capable of displaying the dashboard 700 on one or more displays and of receiving commands or instructions from the dashboard 700, such as commands or instructions that may be entered by a user. The application programs 818 may additionally include one or more machine executable instruction sets (i.e., monitoring module 818c) capable of monitoring the signals received from the one or more sensors 218 and/or the flow meter 624.

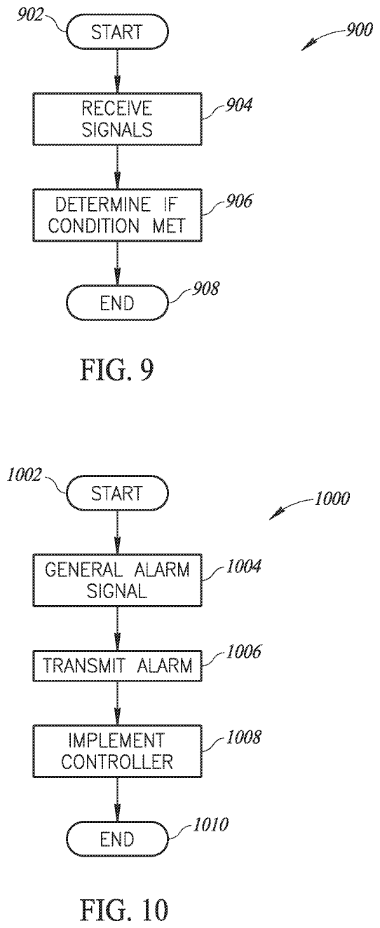

FIG. 9 shows a method 900 of monitoring the signals received from one or more of the sensors 218 in one of the modular dwelling units 502, according to at least one illustrated implementation. The method 900 starts at 902, for example on powering up of the processor-based system 800, or on invocation by a calling routine.

At 904, the processor-based system 800 receives one or more signals in which each signal may be received from a respective sensor 218 and/or flow meter 624. In some implementations, the sensors 218 may include one or more of the water sensor 218a, the humidity sensor 218b, the temperature sensor 218c, the carbon monoxide sensor 218d, the smoke detector 218e, the passive infrared motion detector 218f, the image sensor 218g, the microphone 218h, the accelerometer 218i, the impact sensor 218j, the pressure sensor 218k, the load cell 218l, the air flow sensor 218m, the gas flow sensor 218n, the light detection and ranging (LIDAR) sensor 218o, and/or the radar sensor 218p. In some implementations, the signal received from one of the sensors may note the presence or absence of a specific condition. The simal for the water sensor 218a, for example, may be a binary signal that indicates the presence of a fluid or an absence of the fluid. In some implementations, the signal received from the sensor may be indicative of a measurement of some physical condition within the modular dwelling unit 502. The signal received from the temperature sensor 218c may indicate the measurement of the temperature in the environment surrounding the temperature sensor 218c. In some implementations, the signal from the sensor 218 may indicate a condition of an occupant or inhabitant of the modular dwelling unit 502. For example, the signal from the accelerometer 218i may indicate rate and/or direction of motion by an occupant of the interior 512 of the modular dwelling unit 502.

At 906, the processor-based system 800 compares each signal received from a respective sensor 218 to a corresponding threshold value or condition to determine if a condition is met. In some implementations, the processor-based system 800 may compare the magnitude of the signal received from the sensor 218 to determine if the magnitude of the simal meets or exceeds the corresponding threshold value. In some implementations, for example, the magnitude of the signal associated with the carbon monoxide sensor 218d may be compared to a corresponding carbon monoxide threshold value or condition to determine if the magnitude of the received signal meets or exceeds the threshold value or condition. If the threshold value or condition is met or exceeded, the processor-based system 800 may execute a method for generating and/or transmitting an alarm, as discussed below.

In some implementations, the processor-based system 800 may compare one or more signals received from respective sensors 218 to determine if a corresponding threshold value or condition is not met. In some implementations, for example, the processor-based system 800 may compare the signal generated by the temperature sensor 218c to determine if a threshold value or condition is met (e.g., if a threshold temperature is met). If not, the processor-based system 800 may execute a method for generating and/or transmitting an alarm, as discussed below.

The method 900 terminates at 908, for example, until invoked again.

FIG. 10 shows a method 1000 of generating and transmitting an alarm signal, according to at least one illustrated implementation. The method 1000 starts at 1002, for example on powering up of the processor-based system 800, or on invocation by a calling routine such as the method 900.

At 1002, the processor-based device 800 generates an alarm signal. Such an alarm signal may be generated based upon a comparison of one or more signals received from respective sensors 218 and/or flow meters 624. In some implementations, the alarm signal may be generated based upon one of a first defined condition not being met or a second defined condition being met. Such first defined condition and/or second defined condition may be compared to signals received from sensors 218 that are associated with a sensed physical characteristic of the modular dwelling unit ambient temperature) and/or that are associated with a sensed physical characteristic of any inhabitant of the modular dwelling unit 502 (e.g., movement). In some implementations, the alarm signal may be generated based upon a combination of at least one defined condition not being met and of at least another defined condition being met. For example, in some implementations, an alarm signal indicating a leak condition may be generated upon a first defined condition not being met (e.g., receiving no signals from any of the water-using components (e.g., a faucet 622a, a toilet 622b, and/or a showerhead 622c) fluidly coupled to a supply network (e.g., first supply network 606 and/or second supply network 616 in FIG. 6) indicating that such water-using component is in use) and a second defined condition being met (e.g., receiving a signal from the flow meter 624 indicating that water is flowing in the supply system that is fluidly coupled to the faucet 622a, the toilet 622b, and the showerhead 622c).

At 1004, the processor-based device 800 may transmit the alarm signal generated at 1002, For example, the alarm signal may be transmitted to one or more actuators 636, valves 614/620, and/or other control component associated with the modular dwelling unit 502. Such alarm signals may result in a responsive action being taken upon detecting that at least one of the first defined condition has not been met and/or that the second defined condition has been met. For example, in some implementations, the alarm signal may be transmitted to one or more valves 614/620 to shut off the supply of a fluid in a supply network (e.g., first supply network 606 and/or second supply network 616 in FIG. 6). In some implementations, the alarm signal may be transmitted to the dashboard 700 that may be rendered on a display 634. The dashboard 700 may indicate an alarm condition using one or more of loud sounds and/or flashing graphics to attract the attention of a user. The dashboard 700 may additional suggest corrective action that may be taken by the viewer of the dashboard 700 in response to the alarm condition.

The alarm signal may be transmitted to various devices in a number of locations. In some implementations, the alarm signal may be transmitted to a device located in the impacted modular dwelling unit 502. In some implementations, the alarm signal may be transmitted to a device associated with the occupant or inhabitant of the modular dwelling unit 502. In some implementations, the alarm signal may be transmitted to all modular dwelling units 502 in a modular building 500 except for the modular dwelling unit 502 with which the alarm signal is associated. In some implementations, the alarm signal may be transmitted to a monitoring location that may be in the same modular building 500 as the modular dwelling unit 502 associated with the alarm and/or to a monitoring location that may be remote from the modular dwelling unit 502.

At 1008, the processor-based device 800 may implement the controller 822 that may be used to transmit control signals to one or more of the actuators 636 and/or valves in the modular dwelling unit 502. In some implementations, the controller 822 may be accessed from a device (e.g., the display 634) located within the modular dwelling unit 502 associated with the alarm signal. In some implementations, the controller 822 may be accessed from a device located away from the modular dwelling unit 502 associated with the alarm, such as at a monitoring facility that may be located elsewhere in the modular building 500 or in a remote monitoring facility. In such an implementation, the controller 822 may be restricted to access by an authorized user, such as an authorized building monitor or manager. In some implementations, the controller 822 may be accessed from a remoted device that is associated with the inhabitant and/or occupant of the modular dwelling unit 502 associated with the alarm signal.

The method 1000 terminates at 1010, for example, until invoked again.

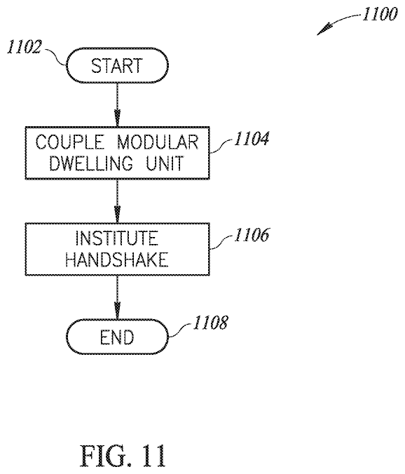

FIG. 11 shows a method 1100 of recognizing and communicatively coupling with a modular dwelling unit 502 that has been added to existing modular dwelling units 502 in a modular building 500, according to at least one illustrated implementation. The method 1100 starts at 1002, for example, when a modular dwelling unit 502 is added to a modular building 500.

At 1104, the new modular dwelling unit 502 is coupled to a set of one or more existing modular dwelling units 502 that comprise a modular building 500. In such an implementation, the modular dwelling unit 502 may have the same or substantially similar dimensions to a type of intermodal container and may include one or more couplers (e.g., twistlock fittings) at appropriate locations such that the modular dwelling unit 502 may be selectively, releaseably, physically coupled and secured to other similarly shaped modular dwelling units 502. In such implementations, the modular dwelling units 502 may include standardized communication interfaces and locations by which the communication systems in each modular dwelling unit 502 may physically connect with each other when such modular dwelling units 502 are physically coupled.

At 1106, the coupled modular dwelling units 502 institute a handshake protocol to become communicatively coupled to each other. Such a handshake protocol could be similar to other such networking handshake protocols by which devices are dynamically added to existing networks. Such handshake protocols may include, for example, or be similar to those handshake protocols used for adding devices to a Bluetooth network, an IEEE 802.11 WiFi network, an Ethernet network, or any other type of communications network. Once the handshake protocol is complete, the new modular dwelling unit 502 may be communicatively coupled to the existing modular dwelling units 502 in the modular building 500.

The method 1100 terminates at 1108, for example, until invoked again.

To the extent that they are not inconsistent with the specific teachings and definitions herein, all of the US patents, US patent application publications, US patent applications, referred to in this specification and/or listed in the Application Data Sheet, including but not limited to U.S. Patent Application Ser. No. 62/666,422, filed May 3, 2018, are hereby incorporated herein by reference in their entirety.

While various aspects and implementations have been disclosed herein, other aspects and implementations will be apparent to those skilled in the art. The present embodiments are susceptible to modifications and alternate constructions from those discussed above. Consequently, the present invention is not limited to the particular embodiments disclosed. Rather, numerous modifications and alternate constructions fall within the spirit and scope of the present disclosure. For example, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location, or other structural elements described as independent structures may be combined. The blocks in the processes described herein need not be performed in the same order as they have been presented, and may be performed in any order(s), unless logic dictates a particular order. Further, blocks that have been presented as being performed separately may in alternative embodiments be performed concurrently. Likewise, blocks that have been presented as being performed concurrently may in alternative embodiments be performed separately. The various aspects and implementations disclosed herein are for purposes of illustration and are not intended to be limiting, with the true scope being indicated by the following claims, along with the full scope of equivalents to which such claims are entitled. It is also to be understood that the terminology used herein is for the purpose of describing particular implementations only, and is not intended to be limiting.

U.S. Provisional Application No. 62/666,422, entitled “MODULAR HOUSING AND RELATED SYSTEMS AND MANUFACTURE,” filed May 3, 2018, to which the present application claims priority,is incorporated herein by reference in its entirety.

What is claimed is:

1. A modular building, comprising:
a plurality of modular dwelling units, each of the modular dwelling units have a respective floor, a respective ceiling, and at least one respective perimeter wall, the respective floor, respective ceiling and at least one respective perimeter wall delimiting a respective interior of the modular dwelling unit from a respective exterior of the modular dwelling unit, the modular dwelling units physically coupled to a number of nearest neighboring ones of the modular dwelling units via at least one coupler, each of the modular dwelling units have a respective set of sensors to monitor a number of physical characteristics of the modular dwelling unit and a number of physical characteristics of any inhabitants of the modular dwelling units, and a respective set of actuators operable to control respective mechanisms of the respective the modular dwelling units; and
at least a first processor-based system comprising at least one processor and at least one non-transitory processor-readable medium that stores at least one of processor-executable instructions or data which, when executed by the at least one processor, causes the at least one processor to:
monitor each sensor of a respective set of sensors for each of a plurality of modular dwelling units, each of the modular dwelling units have a respective floor, a respective ceiling, and at least one respective perimeter wall, the respective floor, respective ceiling and at least one respective perimeter wall delimiting a respective interior of the modular dwelling unit from a respective exterior of the modular dwelling unit, the modular dwelling units physically coupled to a number of nearest neighboring ones of the modular dwelling units via at least one coupler, the respective set of sensors of each of the modular dwelling units operable to sense a number of physical characteristics of the modular dwelling unit and a number of physical characteristics of any inhabitants of the modular dwelling units; and
send signals to the actuators that cause the actuators to control the respective mechanisms based at least in part on one or more physical characteristics sensed by at least one of the sensors. The modular building of claim 1 wherein each of the modular dwelling units further comprise a respective communications hub which provides communications between the respective set of sensors and at least the first processor-based system.

3. The modular building of claim 1 wherein each of the modular dwelling units further comprise a respective communications huh which provides communications between the respective set of sensors and at least the first processor-based system wherein the first processor-based system is a remote cloud-based monitoring system.

1. The modular building of claim 1 wherein the respective set of sensors each include one or more of a water sensor, a humidity sensor, a temperature sensor, a carbon monoxide sensor, a smoke detector, a passive infrared motion detector, an image sensor, a microphone, an accelerometer, an impact sensor, a glass-break sensor, a pressure sensor, a load cell, an air flow sensor, a gas flow sensor, a contact switch, a magnetic switch, a light detection and ranging (LIDAR) sensor, and a radar sensor.

5. The modular building of claim 4 wherein each of the sensors has a unique identifier readable therefrom.

6. The modular building of claim 4 wherein each of the sensors has a wired or optical fiber connection to provide communications therefrom.

7. The modular building of claim 1 wherein the sensors of the respective sets of sensors are each integral to one or more pre-fabricated modular building components.

8. The modular building of claim 7 wherein the modular building component has a unique identifier readable therefrom.

9. The modular building of claim 8 wherein the unique identifier is one of a human-readable symbol, a machine-readable symbol or a radio frequency identification (RFID) transponder encoded identifier.

10. The modular building of any of claims 1 through 9 wherein the respective set of actuators each include one or more of an electric motor, a solenoid, a pump, a cylinder and piston.

11. The modular building of any of claims 1 through 9 wherein the mechanisms include one or more locks, valves, fans, alarms, dampers, or circuit breakers.

12. The modular building of any of claims 1 through 9 wherein at least one of the sensors senses an operational condition or state of a respective one of the actuators.

13. The modular building of any of claims 1 through 9 wherein the modular dwelling units are physically coupled to the number of nearest neighboring ones of the modular dwelling units with a gap between each of the modular dwelling units and all of the other module dwelling units which are the nearest neighboring ones of the modular dwelling units.

14. The modular building of any of claims 1 through 9 wherein the first processor-based system causes at least one actuator to selectively extend and/or retract a latch or other locking mechanism in the event of a disturbance or other occurrence either in or outside of one or more of the modular dwelling units.

15. The modular building of any of claims 1 through 9 wherein the first processor-based system causes at least one actuator to selectively activate and/or deactivate a pump, a heater, a cooling device, a fan, a blower, a damper in the event of an emergency, or to distribute water or fire retardant in the event of a tire.

16. The modular building of any of claims 1 through 9 wherein the first processor-based system causes at least one actuator to activate a pump or open a drain valve in the event or a leak or spill.

17. The modular building of any of claims 1 through 9 wherein the first processor-based system causes at least one actuator to close one or more valves in response to detection of a leak or presence of liquid above a threshold amount in a space or location in one of the modular dwelling units where liquid should not collect or in a location built to collect liquid in the event of a spill or leak.

18. The modular building of any of claims 1 through 9 wherein the first processor-based system causes at least one actuator to present an alarm in the event of a disturbance or emergency.

19. A monitoring system, comprising:
at least a first processor-based system comprising at least one processor and at least one non-transitory processor-readable medium that stores at least one of processor-executable instructions or data which, when executed by the at least one processor, causes the at least one processor to:
monitor each sensor of a respective set of sensors for each of a plurality of modular dwelling units, each of the modular dwelling units have a respective floor, a respective ceiling, and at least one respective perimeter wall, the respective floor, respective ceiling and at least one respective perimeter wall delimiting a respective interior of the modular dwelling unit from a respective exterior of the modular dwelling unit, the modular dwelling units physically coupled to a number of nearest neighboring ones of the modular dwelling units via at least one coupler, the respective set of sensors of each of the modular dwelling units operable to sense a number of physical characteristics of the modular dwelling unit and a number of physical characteristics of any inhabitants of the modular dwelling units; and
produce at least one alert in response to one or more or a combination of the sensed physical characteristics of the modular dwelling unit or the sensed physical characteristics of any inhabitants of the modular dwelling units at least one of not meeting a first defined condition or meeting a second defined condition.

20. The monitoring system of claim 19, wherein the processor-executable instructions or data, when executed by the at least one processor, further causes the at least one processor to present a dashboard representing the sensed physical characteristics of the modular dwelling unit or the sensed physical characteristics of any inhabitants of the modular dwelling units.

21. The monitoring system of claim 19 wherein the processor-executable instructions or data, when executed by the at least one processor, finther causes the at least one processor to present a dashboard representing the sensed physical characteristics of the modular dwelling unit or the sensed physical characteristics of any inhabitants of all of the modular dwelling units to an authorized building monitor.

22. The monitoring system of claim 19 wherein the processor-executable instructions or data, when executed by the at least one processor, further causes the at least one processor to present a dashboard representing the sensed physical characteristics of the modular dwelling unit or the sensed physical characteristics of any inhabitants of a first one of the modular dwelling units to an authorized inhabitant of the first one of the modular dwelling units and not to inhabitants of other ones of the modular dwelling units.

23. The monitoring system of claim 19 wherein the processor-executable instructions or data, when executed by the at least one processor, finther causes the at least one processor to implement a controller that allows remote control over actuators of respective sets of one or more actuators for each of the modular dwelling units.

24. The monitoring system of claim 19 wherein the processor-executable instructions or data, when executed by the at least one processor, further causes the at least one processor to implement a controller that allows local control over actuators of respective sets of one or more actuators for each of the modular dwelling units via one or more authorized inhabitants of the respective modular dwelling units.

25. A modular structure, comprising:
a floor, the floor having an upper surface and a lower surface, the lower surfaced opposed from the upper surface across a thickness of the floor, the upper surface being substantially horizontal and permeable to at least one type of liquid; and
a subfloor, the subfloor having an upper surface, the subfloor spaced relative beneath lower surface of the floor with the upper surface of the subfloor facing toward the lower surface of the floor and a gap between at least a portion of the lower surface of the floor and the upper surface of the subfloor, at least a majority of the upper surface of the subfloor being titled with respect to the upper surface of the floor to drain that at least one type of liquid in one or more defined directions.

26. The modular structure of claim 25 wherein the floor includes a plurality of perforations extending therethrough to provide fluidly communicative paths between the upper and lower surfaces of the floor.

27. The modular structure of claim 25 wherein the modular cture is a modular dwelling unit, and further comprising:
a plurality of modular walls; and
a frame comprised of a plurality of structural members, the floor and the modular walls physically coupled to the frame.

28. The modular structure of claim 27. further comprising:
at least one conduit fluidly coupled to the gap, and which provides a fluid flow path away from the modular dwelling unit.

29. The modular structure of claim 28 wherein the gap and the at least one conduit fluidly isolate the modular dwelling unit from neighboring modular dwelling units.

30. The modular structure of claim 27 wherein the modular dwelling unit has a perimeter and the upper surface of the subfloor slopes downwardly as the subfloor is traversed outwardly from an interior toward at least a portion of the perimeter of the modular dwelling unit.

31. The modular structure of claim 27 wherein the modular dwelling unit has a perimeter and at least one perimeter channel that extends along at least a portion of the perimeter, and the upper surface of the subfloor slopes downwardly as the subfloor is traversed outwardly from an interior toward the at least one perimeter channel.

32. The modular structure of claim 27 wherein the modular dwelling unit has a perimeter and the upper surface of the subfloor slopes downwardly as the subfloor is traversed inwardly from at least a portion of the perimeter toward an inwardly spaced location.

33. The modular structure of claim 27 wherein the modular dwelling unit has a perimeter and at least one interior channel that is spaced away from the perimeter, and the upper surface of the subfloor slopes downwardly as the subfloor is traversed inwardly from at least a portion of the perimeter toward the at least one interior channel.

34. The modular structure of claim 27 wherein the structural members each comprise steel structural members.

35. The modular structure of claim 25 wherein the floor comprises at least a first steel layer.

36. The modular structure of claim 35 wherein the floor further comprises at least a non-metal layer overlying the first steel layer, and the perforations extend through both the first steel layer and the non-metal layer.

37. The modular structure of claim 25, further comprising:
at least one sensor responsive to detection of a presence of a liquid, the at least one sensor operable to produce an alert in response to detection of the presence of the liquid.

38. The modular structure of claim 37 wherein the at least one sensor is responsive to the presence of the liquid in the gap, the at least one sensor operable to produce the alert in response to detection of the presence of the liquid in the gap.

39. The modular structure of claim 37 wherein the at least one sensor is an integral component of the floor or the subfloor.

40. The modular structure of claim 25. further comprising:
at least one valve fluidly coupled to control a flow of water into the modular structure, the at least one valve selectively operable to stop a flow of water into the modular structure.

41. The modular structure of claim 40, further comprising:
at least one sensor responsive to an occurrence of a leak, the at least one sensor operable to produce an alert in response to detection of the occurrence of a leak.

42. The modular structure of claim 41 wherein the at least one valve is communicatively coupled to respond to detection of the occurrence of a leak by the at least one sensor.

43. The modular structure of claim 40 wherein the at least one valve is communicatively coupled to respond to human generated command.

44. The modular structure of claim 25, further comprising:
a plurality of sprinklers;
a first supply network fluidly coupled to provide water to the plurality of sprinklers:
a second supply fluidly coupled to provide water to at least one of a faucet, a toilet, or a shower head; and
at least one valve fluidly coupled to control a flow of via the second supply, the at least one valve selectively operable to stop a flow of water into the modular structure.

45. A modular building, comprising:
a plurality of modular dwelling units, each of the modular dwelling units have a respective floor, a respective ceiling, and at least one respective perimeter wall, the respective floor, respective ceiling and at least one respective perimeter wall delimiting a respective interior of the modular dwelling unit from a respective exterior of the modular dwelling unit, the modular dwelling units physically coupled to a number of nearest neighboring ones of the modular dwelling units via at least one coupler with a gap between each of the modular dwelling units and all of the other module dwelling units which are the nearest neighboring ones of the modular dwelling units.

46. The modular structure of claim 45 wherein the respective floor of each of the modular dwelling units comprises an upper surface and a lower surface, the lower surfaced opposed from the upper surface across a thickness of the floor, the upper surface being substantially horizontal and permeable to at least one type of liquid.

47. The modular structure of claim 46 wherein each of the modular dwelling units further comprises a subfloor, the subfloor having an upper surface, the suhfloor spaced relative beneath lower surface of the floor with the upper surface of the subfloor facing toward the lower surface of the floor and a gap between at least a portion of the lower surface of the floor and the upper surface of the subfloor, at least a majority of the upper surface of the subfloor being titled with respect to the upper surface of the floor to drain that at least one type of liquid in one or more defined directions.

48. The modular structure of claim 47 wherein the floor includes a plurality of perforations extending therethrough to provide fluidly communicative paths between the upper and lower surfaces of the floor.

49. The modular structure of claim 45 wherein the perimeter walls are modular perimeter walls, and further comprising:
a frame comprised of a plurality of structural members, the floor and the modularperimeter walls are physically coupled to the frame.

50. The modular structure of claim 49, further comprising:
a plurality of sealing systems that each provide a respective waterproof and airtight seal between a respective one of the structural members and one of the floor, the ceiling or modular perimeter walls.

51. The modular structure of claim 50 wherein each of the sealing systems includes at least one portion that is repairable or replaceable.

52. The modular structure of claim 50 wherein each of the modular perimeter walls comprises one or more modular perimeter wall panels, the modular perimeter wall panels each comprising a cold rolled steel layer and a thermal and acoustic insulation layer.

53. The modular structure of claim 50 wherein each of the ceilings comprises one or more modular ceiling panels, the modular ceiling panels each comprising a cold rolled steel layer and a thermal and acoustic insulation layer.

54. The modular structure of claim 45 wherein at least a first one of the modular dwelling units is spaced above at least a second one of the modular dwelling units, and at least the second one of the modular dwelling units is spaced laterally from at least a third one of the modular dwelling units, the first, the second, and the third modular dwelling units each being respective modular dwelling units, distinct from one another.

55. A modular building component, comprising:
a pre-fabricated structural member, and
at least one sensor integral to the pre-fabricated structural member.

56. The modular building component of claim 55, further comprising:
at least one wired access connector integral to the pre-fabricated structural member.

57. The modular building component of claim 55, further comprising:
at least one wire, cable or optical fiber integral to the pre-fabricated structural member.

58. The modular building component of claim 55. further comprising:
at least one circuit board integral to the pre-fabricated structural member.

59. The modular building component of claim 55 wherein the pre-fabricated structural member includes at least one passage therein to receive at least one of a wire, a cable, an optical fiber, or a fluid conduit.

60. The modular building component of claim 55 wherein the pre-fabricated structural member is one of a wall panel, a ceiling panel, a floor panel, or a structural member.

61. The modular building component of claim 55 wherein the at least one sensor comprises one or more of a water sensor, a humidity sensor, a temperature sensor, a carbon monoxide sensor, a smoke detector, a passive infrared motion detector, an image sensor, a microphone, an accelerometer, an impact sensor, a pressure sensor, a load cell, an air flow sensor, a gas flow sensor, a light detection and ranging (LIDAR) sensor, and a radar sensor.

62. The modular building component of claim 55 wherein the pre-fabricated structural member is modular wall panel which comprises a cold rolled steel layer and a thermal and acoustic insulation layer.

63. The modular building component of claim 62 wherein the modular wall panel is replaceable as an integral unit.

64. The modular building component of claim 62 wherein the modular wall panel is fire resistant, water resistant, and rot resistant.

65. The modular building component of claim 55 wherein the modular building component has a unique identifier readable therefrom.

66. The modular building component of claim 65 wherein the unique identifier readable is one of a human-readable symbol, a machine-readable symbol or a radio frequency identification (RFID) transponder encoded identifier.

67. A method of operation in a monitoring system that includes at least one processor and at least one non-transitory processor-readable medium that stores at least one of processor-executable instructions or data executable by the at least one processor, the method comprising:
detecting an addition of a new modular dwelling unit to a network of modular dwelling units, each of the modular dwelling units having a respective floor, a respective ceiling, and at least one respective perimeter wall, the respective floor, respective ceiling and at least one respective perimeter wall delimiting a respective interior of the modular dwelling unit from a respective exterior of the modular dwelling unit, the modular dwelling units physically coupled to a number of nearest neighboring ones of the modular dwelling units via at least one coupler, the respective set of sensors of each of the modular dwelling units operable to sense a number of physical characteristics of the modular dwelling unit and a number of physical characteristics of any inhabitants of the modular dwelling units; and
monitoring each sensor of a respective set of sensors for each of a plurality of modular dwelling units, each of the modular dwelling units have a respective floor, a respective ceiling, and at least one respective perimeter wall, the respective floor, respective ceiling and at least one respective perimeter wall delimiting a respective interior of the modular dwelling unit from a respective exterior of the modular dwelling unit, the modular dwelling units physically coupled to a number of nearest neighboring ones of the modular dwelling units via at least one coupler, the respective set of sensors of each of the modular dwelling units operable to sense a number of physical characteristics of the modular dwelling unit and a number of physical characteristics of any inhabitants of the modular dwelling units.

68. The method of claim 67, further comprising:
producing at least one alert in response to one or more or a combination of the sensed physical characteristics of the modular dwelling units or the sensed physical characteristics of any inhabitants of the modular dwelling units at least one of not meeting a first defined condition or meeting a second defined condition.

69. The method of claim 67, further comprising:
in response to one or more or a combination of the sensed physical characteristics of the modular dwelling units or the sensed physical characteristics of any inhabitants of the modular dwelling units at least one of not meeting a first defined condition or meeting a second defined condition, transmitting at least one alert to a device located remotely from the dwelling units.

70. The method of claim 67, further comprising:
in response to one or more or a combination of the sensed physical characteristics of a first one of the modular dwelling units or the sensed physical characteristics of any inhabitants of the first one of the modular dwelling units at least one of not meeting a first defined condition or meeting a second defined condition, transmitting at least one alert to a device located a second one of the dwelling units.

71. The method of claim 67. further comprising:
in response to one or more or a combination of the sensed physical characteristics of a first one of the modular dwelling units or the sensed physical characteristics of any inhabitants of the first one of the modular dwelling units at least one of not meeting a first defined condition or meeting a second defined condition, transmitting at least one alert to a device located at all of the other ones of the dwelling units.

72. The method of claim 67, further comprising:
presenting a dashboard representing the sensed physical characteristics of the modular dwelling units or the sensed physical characteristics of any inhabitants of the modular dwelling units.

73. The method of claim 67, further comprising:
presenting a dashboard representing the sensed physical characteristics of the modular dwelling units or the sensed physical characteristics of any inhabitants of the modular dwelling units at a location that is remote from the modular dwelling units.

74. The method of claim 73 wherein presenting a dashboard includes presenting a dashboard representing the sensed physical characteristics of a first one of the modular dwelling units or the sensed physical characteristics of any inhabitants of the first one of the modular dwelling units via a device operated by a manager of the modular dwelling units.

75. The method of claim 67, further comprising:
presenting a dashboard representing the sensed physical characteristics of a first one of the modular dwelling units or the sensed physical characteristics of any inhabitants of the first one of the modular dwelling units via a device associated with an inhabitant of the first modular dwelling unit.

76. The method of claim 75 wherein presenting a dashboard includes presenting a dashboard representing the sensed physical characteristics of a first one of the modular dwelling units or the sensed physical characteristics of any inhabitants of the first one of the modular dwelling units via a device operated by one of the inhabitants of the first modular dwelling unit.

77. The method of claim 75 wherein presenting a dashboard includes presenting a dashboard representing the sensed physical characteristics of a first one of the modular dwelling units or the sensed physical characteristics of any inhabitants of the first one of the modular dwelling units via a device operated by at least one casework assigned to work with at least one of the inhabitants of the first modular dwelling unit.
